(19) United States
(12) Patent Application Publication
(10) Pub. No.: US 2026/0004564 A1
(43) Pub. Date: Jan. 1, 2026

(54) DATA DETECTION METHOD AND APPARATUS, COMPUTER, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Changan WANG, Shenzhen (CN)

(21) Appl. No.: 19/319,690

(22) Filed: Sep. 4, 2025

Related U.S. Application Data
(63) Continuation of application No. PCT/CN2024/103618, filed on Jul. 4, 2024.

(30) Foreign Application Priority Data
Jul. 4, 2023 (CN) 202310814471.5

(51) Int. Cl. G06V 10/77; G06V 10/74; G06V 10/82

(52) U.S. Cl. CPC G06V 10/7715; G06V 10/761; G06V 10/82

(57) ABSTRACT

A data detection method includes obtaining an image sample, extracting sample features from the image sample, determining a target sample feature with a maximum nearest-neighbor feature distance, determining, based on the nearest-neighbor feature distances of the sample features, (N+1) sample feature categories corresponding to the sample features, N being a positive integer, and training an initial feature classification model based on the (N+1) sample feature categories and the sample features to obtain a trained feature classification model. The nearest-neighbor feature distance of one sample feature is a minimum value of feature distances between the one sample feature and other ones of the plurality of sample features except the one sample feature. The (N+1) sample feature categories include N first feature categories indicating detected data being normal data and a second feature category indicating to perform secondary detection on the detected data.

### CROSS-REFERENCE TO RELATED APPLICATIONS

This application is a continuation of International Application No. PCT/CN2024/103618, filed on Jul. 4, 2024, which claims priority to Chinese Patent Application No. 202310814471.5, filed with the China National Intellectual Property Administration on Jul. 4, 2023 and entitled “DATA DETECTION METHOD AND APPARATUS, COMPUTER, STORAGE MEDIUM, AND PROGRAM PRODUCT,” the entire contents of both of which are incorporated herein by reference.

### FIELD OF THE TECHNOLOGY

This application relates to the technical field of computers, and in particular, to a data detection method and apparatus, a computer, a storage medium, and a program product.

### BACKGROUND OF THE DISCLOSURE

With the development of the 5G industry, autonomous driving, and the like, industries such as consumer electronics and automotive electronics are embracing new growth opportunities. Cameras, as basic visual components of intelligent machines, play the role of human eyes and have an important impact on environmental perception, automated intelligence, and enhancing user experience. Camera modules have a wide range of applications, including common fields such as healthcare, automated teller machines (ATMs), road detection, and modular cameras for precision devices or mobile phones. An increasingly large number of intelligent terminal devices brings a large demand for camera modules, and detection of the camera modules is extremely important. The connector in the camera module plays an important role. However, the connector needs to be soldered during assembly. Various defects such as solder overflow and pin bending often occur, which may directly affect the usage of the terminal. Currently, a deep learning-based target detection method is usually used. All defects are grouped according to differences in appearance features. Defects with similar appearance features are grouped into one group, and related sample images are directionally collected for each group of defects to perform model training. For a relatively robust deep model, generally, approximately 1,000 pictures are generally needed for a single type of defect. However, due to the routine yield control and production line optimization and upgrade of manufacturers, the number of defective samples related to the connector is usually relatively small. Consequently, it is difficult to obtain sufficient samples for model training. Thus, the accuracy and efficiency of data detection are relatively low.

### SUMMARY

In accordance with the disclosure, there is provided a data detection method including obtaining an image sample, extracting a plurality of sample features from the image sample, and determining a target sample feature with a maximum nearest-neighbor feature distance among the plurality of sample features. The nearest-neighbor feature distance of one sample feature is a minimum value of feature distances between the one sample feature and other ones of the plurality of sample features except the one sample feature. The method further includes determining, based on the nearest-neighbor feature distances of the plurality of sample features, (N+1) sample feature categories corresponding to the plurality of sample features, N being a positive integer, and training an initial feature classification model based on the (N+1) sample feature categories and the plurality of sample features to obtain a trained feature classification model. The (N+1) sample feature categories include N first feature categories configured for indicating detected data being normal data and a second feature category configured for indicating to perform secondary detection on the detected data.

Also in accordance with the disclosure, there is provided a data detection method including obtaining a target image feature of a target image, predicting an image feature category corresponding to the target image feature through a trained feature classification model, and performing image abnormality detection on the target image based on the image feature category corresponding to the target image feature. The trained feature classification model is obtained by training a plurality of sample features extracted from an image sample and (N+1) sample feature categories corresponding to the plurality of sample features. N is a positive integer. The (N+1) sample feature categories are obtained by dividing the plurality of sample features based on feature distances corresponding to the plurality of sample features. The target sample feature is a sample feature with a maximum corresponding feature distance among the plurality of sample features. A feature distance corresponding to one sample feature is a minimum value of feature distances between the one sample feature and other ones of the plurality of first sample features except the first sample feature. The (N+1) sample feature categories include N first feature categories configured for indicating detected data being normal data and a second feature category being configured for indicating to perform secondary detection on the detected data.

Also in accordance with the disclosure, there is provided a computer device including a memory storing a computer program and a processor configured to invoke the computer program to cause the computer device to obtain an image sample, extract a plurality of sample features from the image sample, and determine a target sample feature with a maximum nearest-neighbor feature distance among the plurality of sample features. The nearest-neighbor feature distance of one sample feature is a minimum value of feature distances between the one sample feature and other ones of the plurality of sample features except the one sample feature. The processor is further configured to invoke the computer program to cause the computer device to determine, based on the nearest-neighbor feature distances of the plurality of sample features, (N+1) sample feature categories corresponding to the plurality of sample features, N being a positive integer, and train an initial feature classification model based on the (N+1) sample feature categories and the plurality of sample features to obtain a trained feature classification model. The (N+1) sample feature categories include N first feature categories configured for indicating detected data being normal data and a second feature category configured for indicating to perform secondary detection on the detected data.

### BRIEF DESCRIPTION OF THE DRAWINGS

FIG. 1A is a diagram showing a network interaction architecture for data detection according to an embodiment of this application.

FIG. 1B is a schematic diagram showing an architecture in a sample acquisition scene according to an embodiment of this application.

FIG. 2 is a schematic diagram showing a data detection scene according to an embodiment of this application.

FIG. 3 is a flowchart of a data detection method according to an embodiment of this application.

FIG. 4 is a schematic diagram of a feature detection network according to an embodiment of this application.

FIG. 5 is a schematic flowchart showing obtaining an initial sample feature according to an embodiment of this application.

FIG. 6 is a schematic diagram showing a feature fusion processing scene according to an embodiment of this application.

FIG. 7 is a schematic flowchart showing feature reduction according to an embodiment of this application.

FIG. 8 is a schematic diagram showing a feature reduction scene according to an embodiment of this application.

FIG. 9 is a schematic diagram showing an image detection scene according to an embodiment of this application.

FIG. 10 is a flowchart of another data detection method according to an embodiment of this application.

FIG. 11 is a schematic diagram of a data detection apparatus according to an embodiment of this application.

FIG. 12 is a schematic diagram of another data detection apparatus according to an embodiment of this application.

FIG. 13 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person skilled in the art based on the embodiments of this application without making inventive efforts shall fall within the protection scope of this application.

In this application, if data of an object (such as a user) needs to be collected, before or during collecting, a prompt interface or a pop-up window is displayed. The prompt interface or the pop-up window is configured to prompt the user that some data (such as an image sample) is currently being collected. Operations related to data obtaining start to be performed only after a confirmation operation of the user for the prompt interface or the pop-up window is obtained; otherwise, the operations end. In addition, the obtained user data is used in a scene, an objective, or the like that is appropriate and legal. In some embodiments, in some scenes in which user data needs to be used but user authorization is not obtained, authorization may further be requested from the user, and the user data is used after the authorization passes. The use of the user data complies with related provisions of laws and regulations.

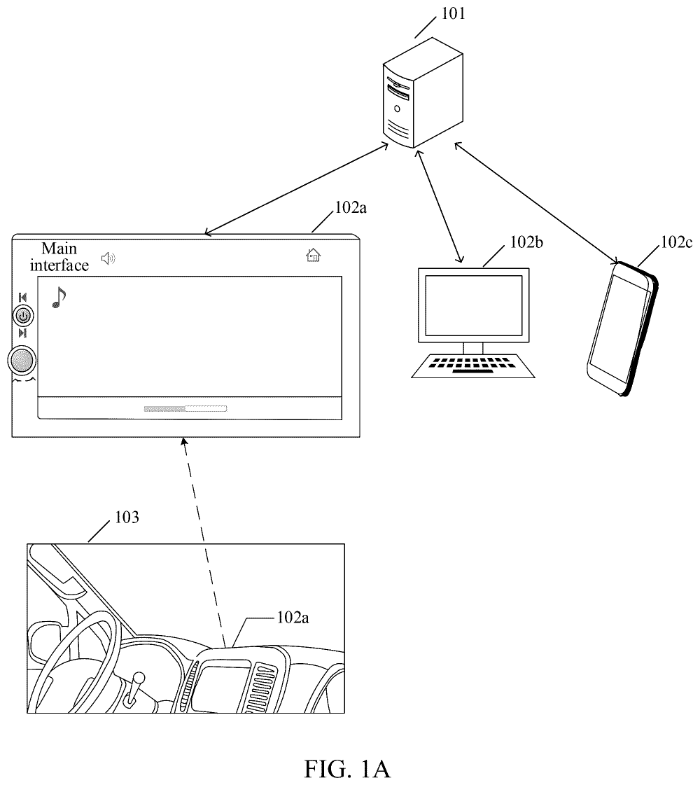

In an embodiment of this application, FIG. 1A is a diagram showing a network interaction architecture for data detection according to an embodiment of this application. As shown in FIG. 1A, a computer device 101 may obtain an image sample for model training from any one or more business devices, such as a business device 102a, a business device 102b, or a business device 102c. “A plurality of” in this application refers to at least two. Alternatively, the computer device 101 may directly obtain an image sample from local storage space (i.e., storage space of the computer device 101), obtain an image sample from cloud storage space or a blockchain network, or the like. This is not limited herein. The image sample refers to a normal sample (i.e., a positive sample), i.e., an image obtained by performing image acquisition on a to-be-detected object that is normal and non-defective. That is, the image sample is a sample that may be determined as normal data. The to-be-detected object may be a connector in a camera module, or another object that needs to be detected, such as a lens element or another industrial element in the camera module. This is not limited herein. Further, the computer device 101 may perform model training on an initial feature classification model using the obtained image sample to obtain a trained feature classification model.

When the computer device obtains the image sample, a possible manner may refer to FIG. 1B. FIG. 1B is a schematic diagram showing an architecture in a sample acquisition scene according to an embodiment of this application. As shown in FIG. 1B, assuming that the to-be-detected object is a connector in a camera module 104, the camera module 104 may be acquired using an image acquisition device 105 to obtain a to-be-detected object image. A computer device 106 obtains the to-be-detected object image acquired by the image acquisition device 105 and performs image recognition on the to-be-detected object image to obtain the image sample. Specifically, the to-be-detected object image may be determined as the image sample. Alternatively, a region in which the to-be-detected object is located may be recognized from the to-be-detected object image, and the region in which the to-be-detected object is located is determined as the image sample. The image obtaining device 105 may be a component integrated into the computer device 106 (for example, but not limited to, a camera in the computer device 106), or may be a device independent of the computer device 106 (for example, but not limited to, a camera or a business device having a camera function).

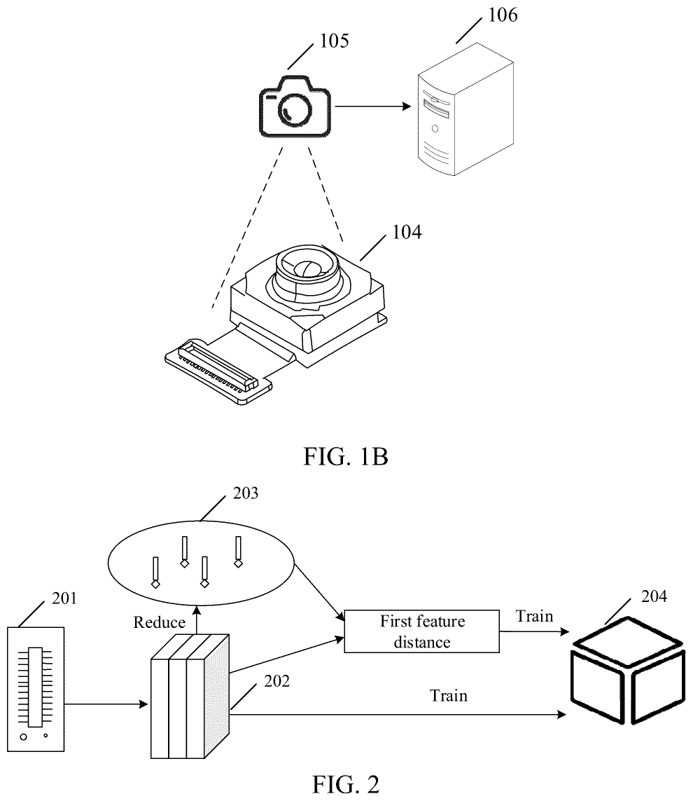

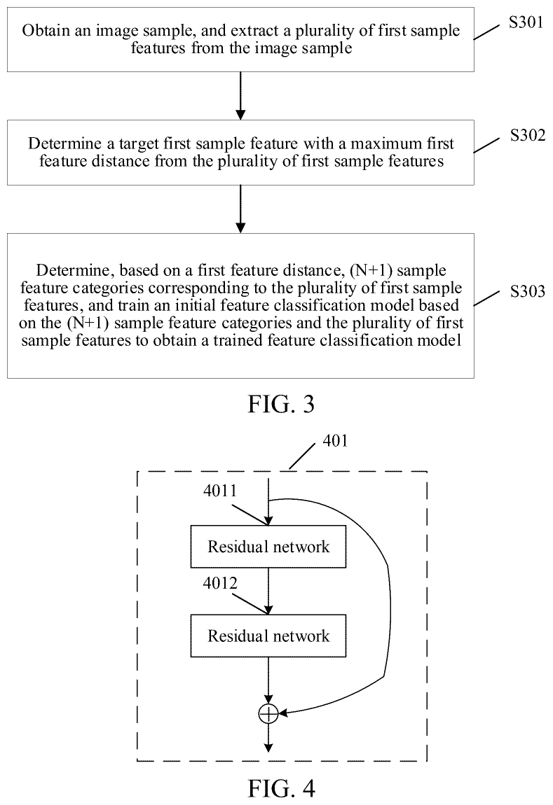

Specifically, FIG. 2 is a schematic diagram showing a data detection scene according to an embodiment of this application. As shown in FIG. 2, a computer device may obtain an image sample for a to-be-detected object 201 and extract a plurality of first sample features 202 from the image sample. The first sample feature 202 refers to a feature obtained after feature parsing is performed on the image sample. Further, a target first sample feature 203 with a maximum first feature distance may be determined from the plurality of first sample features 202. That is, the plurality of first sample features 202 include the target first sample feature 203. The first feature distance of the target first sample feature 203 is the largest, which indicates that similarity between the target first sample feature 203 and another first sample feature is the smallest, and the target first sample feature 203 is a most representative first sample feature in the plurality of first sample features 202. Specifically, the number of the plurality of first sample features 202 is M, and M is a positive integer. The computer device may determine the target first sample feature from the M first sample features based on first feature distances between each first sample feature and other first sample features except the first sample feature. The target first sample feature refers to a first sample feature with a maximum corresponding first feature distance among the plurality of first sample features. According to the foregoing process, resource control may be performed on the plurality of first sample features so that the target first sample feature forms a compact set of normal features extracted from the plurality of first sample features, and features of a high-confusion region may be more accurately expressed. Thus, memory consumption caused by saving sample features, time consumption during subsequent image abnormality detection, and the like may be reduced. In addition, model training may be implemented without a negative sample, thereby improving the convenience, efficiency, and accuracy of sample obtaining for model training. The first feature distance refers to a smallest feature distance in feature distances between a corresponding first sample feature and other first sample features. Specifically, reference may be made to the related descriptions in operation S302 in FIG. 3 below, which will not be described herein. In this disclosure, the first sample feature is also referred to as a “candidate sample feature” or simply “sample feature,” and the target first sample feature is also simply referred to as a “target sample feature.”

Further, the computer device may divide the plurality of first sample features 202 into (N+1) categories based on the first feature distance, that is, determine (N+1) sample feature categories corresponding to the plurality of first sample features 202. The (N+1) feature categories may include N first feature categories and a second feature category, and N is a positive integer. Further, an initial feature classification model may be trained based on the plurality of first sample features 202 and the (N+1) sample feature categories corresponding to the plurality of first sample features 202 to obtain a trained feature classification model 204, thereby realizing end-to-end training of the model for subsequent abnormality detection of the image, and thus improving the efficiency and accuracy of the image detection.

The business device mentioned in this embodiment of this application may be a computer device. The computer device in the embodiments of this application includes but is not limited to a terminal device or a server. In other words, the computer device may be a server or a terminal device, or may be a system including a server and a terminal device. The terminal device mentioned above may be an electronic device, which includes, but is not limited to, a mobile phone, a tablet computer, a desktop computer, a notebook computer, a palmtop computer, an in-vehicle device, an augmented reality/virtual reality (AR/VR) device, a helmet-mounted display, a smart television, a wearable device, a smart speaker, a digital camera, a camera, and another mobile internet device (MID) having a network access capability, or a terminal device in scenes such as a train, a ship, and flight. As shown in FIG. 1A, the terminal device may be a notebook computer (as shown by the business device 102b), a mobile phone (as shown by the business device 102c), an in-vehicle device (as shown by the business device 102a), or the like. FIG. 1 merely shows some devices. In some embodiments, the business device 102a refers to a device located in a vehicle 103. The server mentioned above may be an independent physical server, a server cluster or distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, vehicle-infrastructure cooperation, a content delivery network (CDN), and a big data and artificial intelligence platform.

In some embodiments, the data involved in this embodiment of this application may be stored in the computer device, or may be stored based on a cloud storage technology or a blockchain network. This is not limited herein.

Further, FIG. 3 is a flowchart of a data detection method according to an embodiment of this application. As shown in FIG. 3, the data detection process includes the following operations.

Operation S301: Obtain an image sample, and extract a plurality of first sample features from the image sample.

In this embodiment of this application, the computer device may obtain the image sample. Specifically, A to-be-detected object image may be acquired for a to-be-detected object, and a region including the to-be-detected object is clipped from the to-be-detected object image to obtain the image sample. Alternatively, a to-be-detected object image may be acquired for the to-be-detected object, image registration is performed on the to-be-detected object image to obtain a registered image, and a region including the to-be-detected object is clipped from the registered image to obtain the image sample. When the image sample is acquired, the to-be-detected object is a normal and non-defective object. Specifically, the to-be-detected object image may be inputted into an object detection model to perform object detection, and a region of the to-be-detected object in the to-be-detected object image is determined. The region of the to-be-detected object in the to-be-detected object image is clipped and used as the image sample. The object detection model may be a trained model configured for detecting the to-be-detected object. Alternatively, the to-be-detected object image may be acquired for the to-be-detected object, and a template image corresponding to the to-be-detected object is obtained. The template image refers to a standard image generated during a design of the to-be-detected object. Image registration is performed on the to-be-detected object image using the template image to obtain a registered image. A region corresponding to the to-be-detected object is clipped from the registered image and determined as the image sample. For example, the to-be-detected object image is inputted into the object detection model for object detection, and a region of the to-be-detected object in the registered image is determined. The region of the to-be-detected object in the registered image is clipped and used as the image sample. The image registration refers to a process of matching and superimposing two or more images obtained at different times, by different sensors, or under different conditions. The template image refers to a standard image generated during a design of the to-be-detected object. That is, when the to-be-detected object is generated, there is a design drawing of the to-be-detected object, and a planar image of the design drawing of the to-be-detected object may be determined as the template image.

In an image registration manner, when image registration is performed on the to-be-detected object image using the template image to obtain the registered image, the computer device may detect a first object contour of the to-be-detected object in the to-be-detected object image and detect a second object contour of the to-be-detected object in the template image. Contour offset information of the first object contour relative to the second object contour is obtained, and image registration is performed on the to-be-detected object image based on the contour offset information to obtain the registered image. That is, image rotation and offset processing may be performed on the to-be-detected object image based on the contour offset information to obtain the registered image. For example, if the contour offset information of the first object contour relative to the second object contour is “offset leftwards by 5 centimeters, and offset anticlockwise by 5 degrees,” the to-be-detected object image is offset leftwards by 5 centimeters and rotated anticlockwise by 5 degrees based on the contour offset information to obtain the registered image. In this case, clipping the region corresponding to the to-be-detected object from the registered image may be specifically: determining a region corresponding to the first object contour in the registered image as a region corresponding to the to-be-detected object in the registered image, and clipping the region corresponding to the to-be-detected object; or clipping the region corresponding to the to-be-detected object from the registered image based on an object template corresponding to the template image. The object template is configured for representing position information corresponding to the to-be-detected object in the template image. For example, the object template includes “(10, 20) (40, 70).” In this case, a region formed by pixel coordinates (10, 20) to pixel coordinates (40, 70) in the registered image is determined as the region corresponding to the to-be-detected object. Alternatively, the object template may include “(10, 20), a width of 30, and a height of 50.” The object template includes the position information corresponding to the to-be-detected object in the template image.

Alternatively, in an image registration manner, the to-be-detected object image may be convolved using a Gaussian kernel to obtain a feature matrix of pixels included in the to-be-detected object image. The Gaussian kernel may be denoted as σ. Formular I may be referred to for manner of obtaining the feature matrix:

$$H ( x , σ ) = [ \begin{matrix}{L}_{x x} ( x , σ ) & {L}_{x y} ( x , σ ) \\ {L}_{x y} ( x , σ ) & {L}_{y y} ( x , σ )\end{matrix} ] \qquad I$$

As shown in the formula I, H(x, σ) is configured for representing the feature matrix, and σ is configured for representing the Gaussian kernel. Lₓₓ, L_{yy}, and L_{xy} are convolutions of Gaussian second-order differential operators

$$\frac{{\partial }^{2} g}{\partial {x}^{2}} \frac{{\partial }^{2} g}{\partial {y}^{2}} , and \frac{{\partial }^{2} g}{\partial x \partial y}$$

with the to-be-detected object image at x. Formula II may be referred to for the convolution process:

$$L ( x , σ ) = G ( t ) \cdot I ( x , t ) , G ( t ) = \frac{{\partial }^{2} g ( t )}{\partial {x}^{2}} \qquad II$$

As shown in the formula II, I is configured for representing an initial pixel value of a corresponding pixel in the to-be-detected object image at x, and G(t) is configured for representing a Gaussian second-order differential operator. Specifically, as shown in the foregoing formula I to formula II, in a possible feature matrix construction manner (1), the computer device may obtain an initial pixel value (i.e., I) of a pixel in the to-be-detected object image at a first pixel dimension (for example, x). A Gaussian second-order differential operator (which may be denoted as a first Gaussian second-order differential operator), for example,

$$\frac{{\partial }^{2} g}{\partial {x}^{2}} ,$$

of the pixel in the to-be-detected object image in the first pixel dimension is obtained. A Gaussian second-order differential operator (which may be denoted as a second Gaussian second-order differential operator), for example,

$$\frac{{\partial }^{2} g}{\partial {y}^{2}} ,$$

of the pixel in the to-be-detected object image in a second pixel dimension is obtained. A Gaussian second-order differential operator (which may be denoted as a third Gaussian second-order differential operator), for example,

$$\frac{{\partial }^{2} g}{\partial x \partial y} ,$$

of the pixel in the to-be-detected object image in the first pixel dimension and the second pixel dimension is obtained. The first Gaussian second-order differential operator, the second Gaussian second-order differential operator, and the third Gaussian second-order differential operator corresponding to the pixel in the to-be-detected object image and the initial pixel value of the pixel at the first pixel dimension are convolved to determine a first matrix parameter (for example, Lₓₓ(x, σ)), a second matrix parameter (for example, L_{yy}(x, σ)), and the third matrix parameter (for example, L_{xy}(x, σ)). The first matrix parameter, the second matrix parameter, and the third matrix parameter of the pixel form the feature matrix of the pixel.

Alternatively, in a possible feature matrix construction manner (2), according to the foregoing process, the first Gaussian second-order differential operator, the second Gaussian second-order differential operator, and the third Gaussian second-order differential operator corresponding to the pixel in the to-be-detected object image may be obtained. The first Gaussian second-order differential operator, the second Gaussian second-order differential operator, and the third Gaussian second-order differential operator form the feature matrix of the pixel. Formula III may be referred to for a manner of obtaining the feature matrix:

$$H ( f ( x , y ) ) = [ \begin{matrix}\frac{{\partial }^{2} f}{\partial {x}^{2}} & \frac{{\partial }^{2} f}{\partial x \partial y} \\ \frac{{\partial }^{2} f}{\partial x \partial y} & \frac{{\partial }^{2} f}{\partial {y}^{2}}\end{matrix} ] \qquad III$$

As shown in formula III, H(f(x, y)) is configured for representing the feature matrix,

$$\frac{{\partial }^{2} f}{\partial {x}^{2}}$$

is configured for representing the first Gaussian second-order differential operator,

$$\frac{{\partial }^{2} f}{\partial {y}^{2}}$$

is configured for representing the second Gaussian second-order differential operator, and

$$\frac{{\partial }^{2} f}{\partial x \partial y}$$

is configured tor representing the third Gaussian second-order differential operator. The Gaussian second-order differential operator is configured for representing a second derivative of an image.

Certainly, the foregoing is merely examples of several possible manners of obtaining the feature matrix, and other feature matrix construction manners may further be adopted to construct the feature matrix of the pixels included in the to-be-detected object image.

Further, the computer device may weight the feature matrix based on a size of the Gaussian kernel to obtain pixel feature values of the pixels included in the to-be-detected object image. Specifically, a matrix parameter weight for the feature matrix may be obtained, and the feature matrix is weighted using the matrix parameter weight to obtain the pixel feature values of the pixels included in the to-be-detected object image. For example, in the feature matrix construction manner (1), the size of the Gaussian kernel may be processed using the first matrix parameter, the second matrix parameter, and the third matrix parameter to determine the matrix parameter weight for the feature matrix. Alternatively, a default parameter weight is determined as the matrix parameter weight for the feature matrix, such as 0.9 or 0.912. The feature matrix is weighted using the matrix parameter weight to obtain the pixel feature values of the pixels included in the to-be-detected object image. Formula IV may be referred to for a possible generation process of the pixel feature value:

$$det ( H ) = {L}_{xx} {L}_{yy} - {( β {L}_{xy} )}^{2} \qquad IV$$

As shown in the formula IV, β is configured for representing the matrix parameter weight for the feature matrix, Lₓₓ is configured for representing the first matrix parameter, L_{yy} is configured for representing the second matrix parameter, and L_{xy} is configured for representing the third matrix parameter. det(H) is configured for representing the pixel feature value.

For example, in the feature matrix construction manner (2), the default parameter weight may be determined as the matrix parameter weight for the feature matrix, and the feature matrix is weighted using the matrix parameter weight to obtain the pixel feature values of the pixels included in the to-be-detected object image. According to the foregoing process, pixel processing of the to-be-detected object image may be implemented based on the Gaussian kernel, and a size of the to-be-detected object image does not need to be updated, which may improve the data processing efficiency.

Further, non-maximum suppression may be performed on the to-be-detected object image using the pixel feature values of the pixels included in the to-be-detected object image to obtain an initial feature point of the to-be-detected object image. The non-maximum suppression refers to processing of suppressing a non-maximum element and is configured for performing a local maximum search. Specifically, the pixel feature value of the pixel included in the to-be-detected object image may be compared with pixel feature values of adjacent pixels of the pixel in the to-be-detected object image. If the pixel feature value of the pixel is a maximum value or a minimum value of the pixel feature value of the pixel and the pixel feature values of the adjacent pixels of the pixel, the pixel is determined as the initial feature point. If the pixel feature value of the pixel is neither the maximum value nor the minimum value of the pixel feature value of the pixel and the pixel feature values of the adjacent pixels of the pixel, the pixel is not processed.

There are a plurality of pixels. According to the foregoing process, the pixel feature value of any pixel may be obtained, and the initial feature point of the to-be-detected object image is determined from the plurality of pixels included in the to-be-detected object image.

Further, extremum detection may be performed on the initial feature point to obtain a first feature point of the to-be-detected object image. For example, extremum detection may be performed on the initial feature point using a three-dimensional linear interpolation method to obtain the first feature point of the to-be-detected object image so that some points whose pixel feature values are less than a particular threshold may be removed, the number of feature points that need to be processed is reduced, and meanwhile, it may be ensured that sufficient representative pixels are obtained, thereby further improving the efficiency of data detection. Further, wavelet features of the first feature point may be detected, and a main feature direction of the first feature point is determined based on the wavelet features of the first feature point. Specifically, a direction of a wavelet feature having a maximum modulus value among the wavelet features of the first feature point may be determined as the main feature direction of the first feature point. Specifically, there may be a plurality of first feature points. A feature point region of a j^{th} first feature point may be constructed, wavelet features in the feature point region of the j^{th} first feature point are obtained, and a direction of a wavelet feature having a maximum modulus value among the wavelet features in the feature point region of the j^{th} first feature point is determined as a main feature direction of the j^{th} first feature point, where j is a positive integer and is less than or equal to the number of first feature points. Further, a first feature vector of the first feature point may be constructed using the main feature direction of the first feature point. Specifically, a feature neighborhood may be constructed using the j^{th} first feature point, and E rectangular regions are selected from the feature neighborhood. Haar wavelet responses corresponding to the E rectangular regions of the j^{th} first feature point are obtained based on the main feature direction of the j^{th} first feature point, and an accumulated value of the E Haar wavelet responses of the j^{th} first feature point is determined as the first feature vector of the j^{th} first feature point, where E is a positive integer. The Haar wavelet response is configured for representing a grayscale value difference of a corresponding rectangular region. Further, a second feature point in the template image may be detected, and a second feature vector of the second feature point is constructed. For a process of detecting the second feature point, reference may be made to the foregoing process of detecting the first feature point. For a process of constructing the second feature vector, reference may be made to the foregoing process of constructing the first feature vector. Details are not described herein again. Further, image registration may be performed on the foregoing to-be-detected object image using the first feature vector and the second feature vector to obtain the registered image. For example, image registration may be performed on the to-be-detected object image and the template image through similarity between the first feature vector and the second feature vector to obtain the registered image. In this case, the computer device may clip the region corresponding to the to-be-detected object from the registered image based on the object template corresponding to the template image. The object template is configured for representing position information corresponding to the to-be-detected object in the template image.

The foregoing image registration manners are merely examples of several possible image registration manners and are not limited to the foregoing implementation process. For example, an image registration manner based on template matching, an image registration manner based on grayscale matching, an image registration manner based on features (such as speed up robust feature (SURF) points), or an image registration manner based on domain transformation (such as Fourier transformation, Walsh transformation, or wavelet transformation) may further be used. This is not limited herein. For example, a to-be-detected image feature of the to-be-detected object image may be obtained, and a to-be-detected feature descriptor is generated for the to-be-detected image feature. A template image feature of the template image is obtained, and a template feature descriptor is generated for the template image feature. The to-be-detected feature descriptor is compared with the template feature descriptor, and image registration is performed on the to-be-detected object image based on a comparison result to obtain a registered image. The SURF point is a scale-invariant feature point. When acquiring the image of the to-be-detected object, a quality inspection device is usually limited by various factors such as a sample placement angle and stability of a robot arm. Consequently, angles of imaging results at the same position are inconsistent. For some positions of the to-be-detected object (for example, a connector), the regularity of the pins needs to be analyzed, and inconsistency of image angles causes an additional error, resulting in missed detection. Thus, the accuracy of data detection is relatively low. Image registration is performed on the to-be-detected object image so that imaging of the to-be-detected object in the image sample is more standard, and the detection of the to-be-detected object causes no or only a few additional errors, which may improve the accuracy of data detection. Meanwhile, in the image sample, only the imaging region corresponding to the to-be-detected object is clipped, and a main region in which the to-be-detected object is distributed may be extracted to facilitate subsequent analysis. In addition, foreign object interference from a surrounding background is avoided to some extent, and the accuracy of data detection is improved.

Further, a plurality of first sample features may be extracted from the image sample. Specifically, the computer device may divide the image sample into M sample image blocks and extract first sample features corresponding to the M sample image blocks. The computer device may extract initial image features from the M sample image blocks. Further, M initial image features may be determined as M first sample features of the image sample. Alternatively, the initial image feature is convolved to obtain a residual feature corresponding to the image sample, and feature enhancement is performed on the residual feature using the initial image feature to obtain an initial sample feature of the image sample. Specifically, the M initial image features are convolved to obtain residual features corresponding to the M sample image blocks forming the image sample. Feature enhancement is performed on the residual feature corresponding to the initial image feature using the initial image feature of each sample image block to obtain the initial sample feature of the sample image block. In this case, the initial sample feature includes sample block features corresponding to the M sample image blocks forming the image sample, or the sample block features corresponding to the M sample image blocks forming the image sample may be obtained according to the initial sample feature. M is a positive integer. Specifically, the initial image feature (for example, recorded as \tilde{x}) may be inputted into a feature detection model. In a residual network included in the feature detection model, the initial image feature is convolved to obtain a residual feature F (\tilde{x}) corresponding to the image sample, and feature enhancement is performed on the residual feature using the initial image feature to obtain an initial sample feature of the image sample, which is denoted as F(\tilde{x})+\tilde{x}. There may be one or more residual networks. For example, FIG. 4 is a schematic diagram of a feature detection network according to an embodiment of this application. As shown in FIG. 4, assuming that the feature detection model 401 includes a residual network 4011 and a residual network 4012, the computer device may input the initial image feature into the feature detection model 401 and convolve the initial image feature in the residual network 4011 included in the feature detection model 401 to obtain a first residual feature. The first residual feature is convolved in the residual network 4012 included in the feature detection model 401 to obtain a second residual feature. Feature enhancement is performed on the second residual feature using the initial image feature to obtain an enhanced sample feature of the image sample, and the enhanced sample feature is determined as the initial sample feature. For the sample block feature corresponding to each sample image block, sample block features of adjacent sample image blocks of the sample image block are fused to obtain a first sample feature of the sample image block. Specifically, feature fusion is performed on a sample block feature corresponding to a k^{th} sample image block and sample block features of adjacent sample image blocks of the k^{th} sample image block to obtain a first sample feature of the k^{th} sample image block, until first sample features corresponding to the M sample image blocks are obtained. k is a positive integer less than or equal to M.

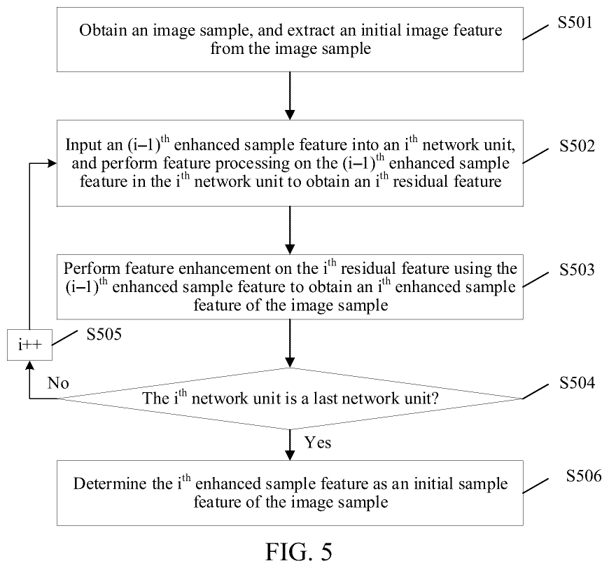

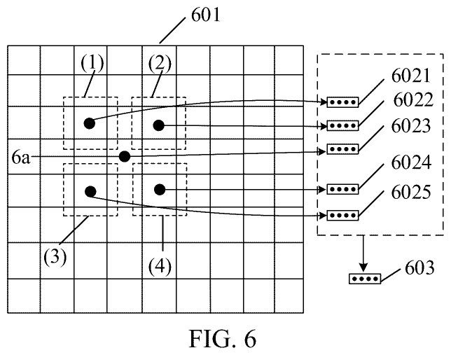

When the initial image feature is convolved to obtain the residual feature corresponding to the image sample, and feature enhancement is performed on the residual feature using the initial image feature to obtain the initial sample feature of the image sample, specifically, in an i^{th} network unit, channel downsampling may be performed on an (i−1)^{th} enhanced sample feature to obtain an i^{th} downsampling feature. When i is a first initial value, the (i−1)^{th} enhanced sample feature is the initial image feature. When i is not the first initial value, the (i−1)^{th} enhanced sample feature is an output feature of an (i−1)^{th} network unit. The i^{th} downsampling feature is convolved to obtain an i^{th} convolution feature corresponding to the image sample. Channel upsampling is performed on the i^{th} convolution feature to obtain an i^{th} residual feature corresponding to the image sample. Feature enhancement is performed on the i^{th} residual feature using the (i−1)^{th} enhanced sample feature to obtain an i^{th} enhanced sample feature of the image sample. If the i^{th} network unit is a last network unit, the i^{th} enhanced sample feature is determined as the initial sample feature of the image sample. If the i^{th} network unit is not the last network unit, incremental processing is performed on i, and the process of performing, in an i^{th} network unit, channel downsampling on an (i−1)^{th} enhanced sample feature to obtain an i^{th} downsampling feature is performed again. Specifically, FIG. 5 below may be referred to for a process of obtaining the initial sample feature. FIG. 5 is a schematic flowchart showing obtaining an initial sample feature according to an embodiment of this application. No more specific description is provided herein.

When for the sample block feature corresponding to each sample image block, sample block features of adjacent sample image blocks of the sample image block are fused to obtain a first sample feature of the sample image block, the sample block features of the adjacent sample image blocks of the k^{th} sample image block may be obtained. k is a positive integer. Further, feature fusion may be performed on the sample block features of the adjacent sample image blocks of the k^{th} sample image block and the sample block feature corresponding to the k^{th} sample image block to obtain the first sample feature of the k^{th} sample image block. When k is M, the first sample features corresponding to the M sample image blocks are obtained. Alternatively, feature fusion is performed on the sample block features of the adjacent sample image blocks of the k^{th} sample image block to obtain an adjacency-enhanced feature of the k^{th} sample image block. For example, pooling is performed on the sample block features of the adjacent sample image blocks to obtain the adjacency-enhanced feature of the k^{th} sample image block. For example, if the number of adjacent sample image blocks is k′, and k′ is a positive integer, the sample block feature of the adjacent sample image block of the k^{th} sample image block may be denoted as f_{kk′}, k′∈{1, 2, . . . , k′}. Assuming that the pooling is maximum pooling (maxpool), the adjacency-enhanced feature may be denoted as ƒ̅ₖ̅=max(ƒ_{kk′}, k′={1,2, . . . , k′}). Feature fusion (for example, feature concatenation) is performed on the adjacency-enhanced feature of the k^{th} sample image block and the sample block feature corresponding to the k^{th} sample image block to obtain the first sample feature of the k^{th} sample image block.

Specifically, when the sample block features of the adjacent sample image blocks of the k^{th} sample image block are obtained, and the initial sample feature includes the sample block features corresponding to the M sample image blocks forming the image sample, that is, when the initial sample feature obtained through the foregoing process is formed by the sample block features of the sample image blocks, the computer device may directly obtain the sample block features corresponding to the M sample image blocks. Alternatively, the computer device may divide the image sample into M sample image blocks, for example, may obtain a region division size and divide the image sample into M sample image blocks based on the region division size. A default region division size may be determined as the region division size. Alternatively, performance detection is performed on at least two candidate region division sizes, size detection performance corresponding to the at least two candidate region division sizes is determined, and a candidate region division size with the best size detection performance is determined as the region division size. For example, assuming that the region division size is 4*4, a 4*4 region in the image sample is determined as a sample image block. Similarly, M sample image blocks forming the image sample may be obtained. Further, unit pixel features of feature pixels forming the image sample are obtained from the initial sample feature. The feature pixel refers to a pixel that may be mapped to the initial sample feature of the image sample. Feature fusion is performed on the unit pixel features of the feature pixels included in the M sample image blocks to obtain the sample block features corresponding to the M sample image blocks. For example, feature fusion is performed on unit pixel features of feature pixels included in the k^{th} sample image block to obtain the sample block feature of the k^{th} sample image block. The image sample is divided into blocks so that the number of features that need to be subsequently processed may be reduced, and the number of target first sample features that are subsequently used as a basis for image detection may be further reduced, thereby improving the efficiency of data detection, and reducing resources consumed by data processing to some extent.

When feature fusion is performed on the unit pixel features of the feature pixels included in the M sample image blocks to obtain the sample block features corresponding to the M sample image blocks, specifically, pooling may be performed on the unit pixel features of the feature pixels included in the k^{th} sample image block to obtain the sample block feature of the k^{th} sample image block. Alternatively, feature concatenation is performed on the unit pixel features of the feature pixels included in the k^{th} sample image block to obtain the sample block feature of the k^{th} sample image block. Alternatively, mean normalization may be performed on the unit pixel features of the feature pixels included in the k^{th} sample image block to obtain the sample block feature of the k^{th} sample image block. Alternatively, the unit pixel features of the feature pixels included in the k^{th} sample image block may be sampled to obtain to-be-fused pixel features of the feature pixels included in the k^{th} sample image block. Specifically, a sampling size may be determined based on the region division size, and the unit pixel features of the feature pixels included in the k^{th} sample image block are sampled based on the sampling size to obtain the to-be-fused pixel features of the feature pixels included in the k^{th} sample image block. For example, assuming that the region division size is 4*4, the sampling size may be ¼. Feature fusion is performed on the to-be-fused pixel features of the feature pixels included in the k^{th} sample image block to obtain the sample block feature of the k^{th} sample image block. Specifically, feature concatenation may be performed on the to-be-fused pixel features of the feature pixels included in the k^{th} sample image block along a channel dimension to obtain the sample block feature of the k^{th} sample image block. Similarly, the sample block features corresponding to the M sample image blocks may be obtained so that each sample block feature is a multi-scale feature obtained through multi-scale fusion and may include more information, thereby improving the information content of the sample block feature, and improving the data processing accuracy to some extent.

In some embodiments, FIG. 6 may be referred to for the construction of the first sample feature. FIG. 6 is a schematic diagram showing a feature fusion processing scene according to an embodiment of this application. As shown in FIG. 6, assuming that k′ is 4, the computer device may obtain adjacent sample image blocks of a k^{th} sample image block 6a, including an adjacent sample image block (1), an adjacent sample image block (2), an adjacent sample image block (3), and an adjacent sample image block (4), and perform feature fusion on sample block features of the adjacent sample image blocks of the k^{th} sample image block and the sample block feature corresponding to the k^{th} sample image block to obtain the first sample feature of the k^{th} sample image block. For example, feature fusion is performed on a sample block feature 6021 of the adjacent sample image block (1), a sample block feature 6022 of the adjacent sample image block (2), a sample block feature 6025 of the adjacent sample image block (3), a sample block feature 6024 of the adjacent sample image block (4), and a sample block feature 6023 corresponding to the k^{th} sample image block 6a to obtain the first sample feature 603 of the k^{th} sample image block. The feature fusion includes, but is not limited to, feature concatenation. Feature information of the adjacent sample image blocks is introduced based on the sample image block so that the first sample feature of each sample image block is a multi-scale feature, including both the feature information of the first sample image block and the feature information of the adjacent sample image blocks, thereby improving the information content in the feature, and fully considering context information of each sample image block in subsequent processing, and thus improving the data processing accuracy.

Operation S302: Determine a target first sample feature with a maximum first feature distance from the plurality of first sample features.

In this embodiment of this application, the computer device may perform representative feature detection on the first sample features to obtain the target first sample feature. Specifically, the target first sample feature is determined from the M first sample features based on first feature distances corresponding to the first sample features. The first sample features refer to the first sample features corresponding to the M sample image blocks forming the image sample. The target first sample feature refers to a first sample feature with a maximum corresponding first feature distance among the plurality of first sample features, and the first feature distance is a minimum value of feature distances between a first sample feature and other first sample features of the plurality of first sample features except the first sample feature. In this disclosure, the first feature distance is also referred to as a “nearest-neighbor distance” (i.e., feature distance to the nearest neighbor first sample feature), and the maximum first feature distance is also referred to as a “maximum nearest-neighbor distance.” For example, the M first sample features are sequentially denoted as a first sample feature 1, a first sample feature 2, . . . , and a first sample feature M. A first feature distance of the first sample feature 1 is a minimum value of feature distances between the first sample feature 1 and the first sample feature 2 to the first sample feature M; a first feature distance of the first sample feature 2 is a minimum value of feature distances between the first sample feature 2 and the first sample feature 1 and the first sample feature 3 to the first sample feature M; . . . ; and a first feature distance of the first sample feature M is a minimum value of feature distances between the first sample feature M and the first sample feature 1 to the first sample feature M−1. In brief, feature distances may be obtained between each first sample feature and M−1 first sample features except the first sample feature. That is, M−1 feature distances may be obtained for each first sample feature. A minimum value of the M−1 feature distances corresponding to each first sample feature is determined as a first feature distance of the first sample feature. Specifically, the computer device may obtain feature distances between the k^{th} first sample feature and other first sample features except the k^{th} first sample feature and determine a minimum value of the feature distances corresponding to the k^{th} first sample feature as the first feature distance of the k^{th} first sample feature. Similarly, the first feature distances corresponding to the plurality of first sample features may be obtained. Further, the first sample feature with the maximum first feature distance may be determined as the target first sample feature. A feature distance between two first sample features is configured for representing similarity or difference between the two first sample features and may be a Euclidean distance between the two first sample features.

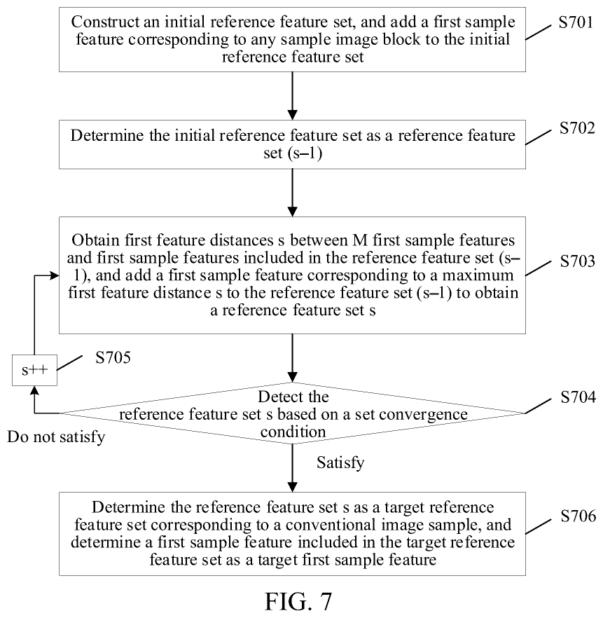

Specifically, an initial reference feature set may be constructed, and a first sample feature corresponding to any sample image block is added to the initial reference feature set. Further, in an s^{th} set construction stage, first feature distances between M first sample features and first sample features included in a reference feature set (which may be referred to as a reference feature set (s−1) for short) in an (s−1)^{th} set construction stage are obtained, and the first feature distances obtained in the s^{th} set construction stage may be denoted as first feature distances s. A first sample feature corresponding to a maximum first feature distance obtained in the s^{th} set construction stage is added to the reference feature set (which may be referred to as the reference feature set (s−1) for short) to obtain a reference feature set (which may be referred to as a reference feature set s) in the s^{th} set construction stage, where s is a positive integer. When s is a second initial value, the reference feature set in the (s−1)^{th} set construction stage is the initial reference feature set. That is, a suffix number may be added after data and is configured for representing a set construction stage of the data, but is not configured for referring to the data. The feature distance (for example, the first feature distance or the second feature distance) in this application refers to a minimum distance between a corresponding first sample feature and a sample feature on which distance detection is performed. For example, a feature distance between a first sample feature A and a plurality of sample features is a minimum value of distances between the first sample feature A and the plurality of sample features. For example, the first feature distance between the k^{th} first sample feature and first sample features included in the initial reference feature set is a minimum value of distances between the k^{th} first sample feature and all first sample features included in the initial reference feature set. If the reference feature set in the s^{th} set construction stage reaches a set convergence condition, the reference feature set in the s^{th} set construction stage is determined as a target reference feature set corresponding to the image sample, and a first sample feature included in the target reference feature set is determined as the target first sample feature. FIG. 7 may be referred to for a specific process of this process. FIG. 7 is a schematic flowchart showing feature reduction according to an embodiment of this application, and will not be described herein.

Operation S303: Determine, based on the first feature distance, (N+1) sample feature categories corresponding to the plurality of first sample features, and train an initial feature classification model based on the (N+1) sample feature categories and the plurality of first sample features to obtain a trained feature classification model.

In this embodiment of this application, N is a positive integer, and the target first sample feature and the trained feature classification model are jointly configured for performing image abnormality detection on a to-be-parsed image (also referred to as a “target image”). Specifically, the number of first sample features is M, and M is a positive integer. The (N+1) sample feature categories include N first feature categories and a second feature category. The N first feature categories are configured for indicating that detected data is normal data, and the second feature category is configured for indicating that secondary detection is performed on the detected data. Specifically, the (N+1) sample feature categories corresponding to the plurality of first sample features may be determined based on the first feature distances between the plurality of first sample features and the target first sample feature. The normal data is configured for indicating that the detected data is accurate and conforms to a data standard of the data. That is, a to-be-detected object (also referred to as a “target object”) corresponding to image data determined as the normal data conforms to a manufacturing standard of the to-be-detected object. For example, the to-be-detected object is a connector of a camera module, and the manufacturing standard of the to-be-detected object includes straight and unbent pins, no solder overflow, and no pin breakage. If the image data for the to-be-detected object is determined as the normal data, the to-be-detected object conforms to the manufacturing standard.

In a model training manner, in a t^{th} iteration, associated sample features fₜ corresponding to pₜ₋₁ target first sample features are determined based on first feature distances between first sample features included in a to-be-detected feature set (which may be denoted as a to-be-detected feature set (t−1)) in a (t−1)^{th} iteration and target first sample features included in an auxiliary feature set (which may be denoted as an auxiliary feature set (t−1)) in the (t−1)^{th} iteration, where t is a positive integer. The to-be-detected feature set is also referred to as a “target feature set.” When t is a third initial value, the to-be-detected feature set in the (t−1)^{th} iteration includes the M first sample features. pₜ₋₁ is a positive integer and refers to the number of target first sample features included in the auxiliary feature set in the (t−1)^{th} iteration. That is, a suffix number may be added after data and is configured for representing an iteration stage of the data, but is not configured for referring to the data. Statistical frequency information corresponding to the pₜ₋₁ target first sample features is determined based on the associated sample features fₜ corresponding to the pₜ₋₁ target first sample features. Specifically, a feature histogram of the pₜ₋₁ target first sample features may be counted based on the associated sample features fₜ corresponding to the pₜ₋₁ target first sample features. The feature histogram is configured for representing the statistical frequency information corresponding to the pₜ₋₁ target first sample features. An associated sample feature fₜ corresponding to a target first sample feature qₜ with maximum statistical frequency information corresponds to a t^{th} sample feature category. That is, a larger number of associated first sample features indicates a larger number of sample image blocks, and a sample image block corresponding to the first sample feature is a common background region on the to-be-detected object and may be used as a background category (i.e., the first feature category). Thus, sample feature classification and sample generation are realized, and dependent data (for example, the trained feature classification model and the target first sample feature) for image abnormality detection may be generated, thereby improving the accuracy of data detection. Until the statistical frequency information corresponding to the pₜ₋₁ target first sample features satisfies a statistical convergence condition, the first sample feature on which sample feature category classification is not performed corresponds to the second feature category, and the determined N sample feature categories (which may be denoted as N first feature categories) and the second feature category form (N+1) sample feature categories. Model training is performed on the initial feature classification model using the (N+1) sample feature categories and the first sample features corresponding to the sample feature categories to obtain the trained feature classification model. That is, sample feature category classification may be first performed on the M first sample features, and then model training is performed. The second feature category is configured for indicating that the detected data is normal but occurs less frequently, or the data is abnormal, that is, accurate detection needs to be further performed. That is, secondary detection needs to be performed on the to-be-detected image.

Alternatively, in the t^{th} iteration, the associated sample features fₜ corresponding to the pₜ₋₁ target first sample features are determined based on the first feature distances between the first sample features included in the to-be-detected feature set in the (t−1)^{th} iteration and the target first sample features included in the auxiliary feature set in the (t−1)^{th} iteration, where t is a positive integer. When t is the third initial value, the to-be-detected feature set in the (t−1)^{th} iteration includes the M first sample features. pₜ₋₁ is a positive integer and refers to the number of target first sample features included in the auxiliary feature set in the (t−1)^{th} iteration. The statistical frequency information corresponding to the pₜ₋₁ target first sample features is determined based on the associated sample features fₜ corresponding to the pₜ₋₁ target first sample features, where the associated sample feature fₜ corresponding to the target first sample feature qₜ with the maximum statistical frequency information corresponds to the t^{th} sample feature category. Further, an updated feature classification model in the (t−1)^{th} iteration is trained using the t^{th} sample feature category and the to-be-detected feature set in the (t−1)^{th} iteration to obtain an updated feature classification model in the t^{th} iteration. When t is the third initial value, the updated feature classification model in the (t−1)^{th} iteration is the initial feature classification model. If the statistical frequency information corresponding to the pₜ₋₁ target first sample features satisfies the statistical convergence condition, the updated feature classification model in the t^{th} iteration is determined as the trained feature classification model. That is, category classification and model training may be performed simultaneously.

In the foregoing two methods, if the statistical frequency information corresponding to the pₜ₋₁ target first sample features does not satisfy the statistical convergence condition, a to-be-detected feature set in the t^{th} iteration is formed by other first sample features in the to-be-detected feature set in the (t−1)^{th} iteration except the associated sample feature fₜ corresponding to the target first sample feature qₜ. An auxiliary feature set in the t^{th} iteration is obtained from the to-be-detected feature set in the t^{th} iteration, or the target first sample feature qₜ in the auxiliary feature set in the (t−1)^{th} iteration may be deleted to obtain the auxiliary feature set in the t^{th} iteration. Further, a value of t is updated, that is, t=t+1, and a next iteration is performed. That is, the foregoing process in the t^{th} iteration is performed again. If the statistical frequency information corresponding to the pₜ₋₁ target first sample features satisfies the statistical convergence condition, the updated feature classification model in the t^{th} iteration is determined as the trained feature classification model.

Entropy of the statistical frequency information corresponding to the pₜ₋₁ target first sample features may be obtained. If the entropy is less than or equal to an entropy convergence threshold (for example, 0.75), it is determined that the statistical frequency information corresponding to the pₜ₋₁ target first sample features satisfies the statistical convergence condition. If the entropy is greater than the entropy convergence threshold, it is determined that the statistical frequency information corresponding to the pₜ₋₁ target first sample features does not satisfy the statistical convergence condition.

The foregoing suffix numbers, such as (t−1), (s−1), t, or s, all represent iteration stages at which corresponding data is generated, and are not configured for referring to the corresponding data. For example, the to-be-detected feature set (t−1) is configured for representing a to-be-detected feature set generated in the (t−1)^{th} iteration. For example, the first feature distance s is configured for representing a first feature distance generated in the s^{th} set construction, and the reference feature set s is configured for representing a reference feature set generated in the s^{th} set construction.

In brief, all first sample features in the to-be-detected feature set (denoted as Q1) may be traversed. For each first sample feature, a proxy feature closest to the first sample feature, i.e., a target first sample feature corresponding to the first feature distance of each first sample feature, is searched in the auxiliary feature set (denoted as Q2) so that all first sample features in Q1 may be associated with Q2. A first sample feature associated with any target first sample feature in Q2 in Q1 may be referred to as an associated sample feature of the target first sample feature. Further, a feature histogram may be counted based on the associated sample features of the target first sample feature in Q2. According to the statistical frequency information of the target first sample features in the feature histogram, the associated sample feature fₜ corresponding to the target first sample feature qₜ with the maximum statistical frequency information is selected, considered as a sample feature category, and denoted as a first sample feature category. The remaining first sample features in Q1 are considered as a single category (denoted as an intermediate category). The initial feature classification model is trained using the first sample feature category and the intermediate category, and after the model converges, the updated feature classification model is obtained. Further, feature reduction is re-performed on all first sample features predicted as the intermediate category to obtain a new Q2, and all first sample features predicted as the intermediate category are used as a new Q1. The foregoing model training process is repeated until Q2 satisfies the statistical convergence condition, the iteration is stopped, and the updated feature classification model in this case is determined as the trained feature classification model.

In some embodiments, p target first sample features may be directly used as sample features for subsequent image abnormality detection. That is, the p target first sample features are added to a feature memory (memory bank), where p is a positive integer and is configured for collectively referring to the number of target first sample features in any iteration. Alternatively, in the t^{th} iteration in any one of the foregoing model training manners, the target first sample feature qₜ is added to the feature memory (memory bank) until the statistical frequency information corresponding to the pₜ₋₁ target first sample features satisfies the statistical convergence condition, and a final feature memory is obtained. The target first sample feature included in the feature memory is configured for performing image abnormality detection on the to-be-parsed image.

Further, FIG. 5 may be referred to for a process of obtaining the initial sample feature. As shown in FIG. 5, the process may include the following operations.

Operation S501: Obtain an image sample, and extract an initial image feature corresponding to the image sample.

In this embodiment of this application, the computer device may obtain the image sample, input the image sample into a feature detection model, and extract the initial image feature corresponding to the image sample. Further, the initial image feature may be determined as an (i−1)^{th} enhanced sample feature. In this case, i is a first initial value. Further, operation S502 is performed.

Operation S502: Input the (i−1)^{th} enhanced sample feature into an i^{th} network unit, and perform feature processing on the (i−1)^{th} enhanced sample feature in the i^{th} network unit to obtain an i^{th} residual feature.

In this embodiment of this application, the i^{th} network unit may include one or more residual networks. It is assumed that the number of residual networks is c, and c is a positive integer. The computer device may input the (i−1)^{th} enhanced sample feature into the i^{th} network unit, and convolve, in a first residual network in the i^{th} network unit, the (i−1)^{th} enhanced sample feature to obtain an i^{th} first residual feature; convolve, in a second residual network in the i^{th} network unit, the i^{th} first residual feature to obtain an i^{th} second residual feature; . . . ; and convolve, in a c^{th} residual network in the i^{th} network unit, an i^{th} (c-1)^{th} residual feature to obtain an i^{th} c^{th} residual feature, use the i^{th} c^{th} residual feature as the i^{th} residual feature, and perform operation S503. The (i−1)^{th} enhanced sample feature may be denoted as \tilde{x}, and the i^{th} residual feature may be denoted as F(\tilde{x}). F( ) is configured for representing the i^{th} network unit.

In any residual network, channel downsampling may be performed on an input feature of the residual network to obtain a downsampling feature. The input feature may be, for example, the (i−1)^{th} enhanced sample feature inputted into the first residual network or the i^{th} first residual feature inputted into the second residual network. Channel downsampling may be performed on the input feature of the residual network using maximum pooling or a convolution kernel whose step size is a sampling interval so that the network receptive field and local translation invariance of the obtained feature may be increased, and fault tolerance of the feature is improved, thereby improving the accuracy of data detection. The sampling interval is a sampling interval to be realized by channel downsampling. The downsampling feature is convolved to obtain a convolution feature corresponding to the image sample. For example, the downsampling feature is convolved using a 3*3 convolution kernel. Channel upsampling is performed on the convolution feature to restore a channel of the feature to an original channel size, so as to obtain an output feature of the residual network, such as the foregoing residual features i. For an implementation process of any one of the foregoing residual networks, reference may be made to the implementation process in this paragraph.

That is, when i is a first initial value (for example, 1), the computer device may perform feature processing on the initial image feature in the first network unit to obtain the first residual feature. When i is a positive integer greater than 1 and less than or equal to the number of network units, the computer device may perform feature processing on the (i−1)^{th} enhanced sample feature in the i^{th} network unit to obtain the i^{th} residual feature.

Operation S503: Perform feature enhancement on the i^{th} residual feature using the (i−1)^{th} enhanced sample feature to obtain an i^{th} enhanced sample feature of the image sample.

In this embodiment of this application, the i^{th} enhanced sample feature is F(\tilde{x})+\tilde{x} so that the number of reference channels of each network unit becomes larger as a network layer deepens. Therefore, the obtained feature may have richer semantic information.

Operation S504: Determine whether the i^{th} network unit is a last network unit.

In this embodiment of this application, whether the i^{th} network unit is the last network unit is detected. For example, it is assumed that there are five network units (blocks) in total, and when i is 5, the i^{th} network unit is the last network unit. Specifically, if the i^{th} network unit is not the last network unit, operation S505 is performed. if the i^{th} network unit is the last network unit, operation S506 is performed.

Operation S505: i++.

In this embodiment of this application, incremental processing is performed on i, that is, a next network unit is executed, and operation S502 is performed again.

Operation S506: Determine the i^{th} enhanced sample feature as the initial sample feature of the image sample.

In this embodiment of this application, the i^{th} enhanced sample feature is determined as the initial sample feature of the image sample.

Further, FIG. 7 may be referred to for a feature reduction process. As shown in FIG. 7, the process may include the following operations.

Operation S701: Construct an initial reference feature set, and add a first sample feature corresponding to any sample image block to the initial reference feature set.

Operation S702: Determine the initial reference feature set as a reference feature set (s−1).

In this embodiment of this application, in this case, s is a second initial value, such as 1.

Operation S703: Obtain first feature distances s between M first sample features and first sample features included in the reference feature set (s−1), and add a first sample feature corresponding to a maximum first feature distance s to the reference feature set (s−1) to obtain a reference feature set s.

In this embodiment of this application, distances between a k^{th} first sample feature and the first sample features included in the reference feature set (s−1) are obtained, and a minimum value of the distances between the k^{th} first sample feature and the first sample features included in the reference feature set (s−1) is determined as a first feature distance s corresponding to the k^{th} first sample feature. The k^{th} first sample feature is an associated sample feature of a first sample feature that is at the first feature distance s from the k^{th} first sample feature in the reference feature set (s−1). Similarly, the first feature distances s corresponding to the M first sample features may be obtained. Further, a first sample feature corresponding to a maximum first feature distance s in the M first sample features is added to the reference feature set (s−1) to obtain the reference feature set s so that a more representative fine-grained feature may be obtained, and resources consumed by feature maintenance are reduced, thereby improving the efficiency of data detection to some extent.

Operation S704: Detect the reference feature set s based on a set convergence condition.

In this embodiment of this application, whether the reference feature set s satisfies the set convergence condition is detected. If the reference feature set does not satisfy the set convergence condition, operation S705 is performed. If the reference feature set s satisfies the set convergence condition, operation S706 is performed. If the reference feature set s reaches a set size threshold, it is determined that the reference feature set s satisfies the set convergence condition. If the reference feature set s does not reach the set size threshold, it is determined that the reference feature set s does not satisfy the set convergence condition. Alternatively, if first feature distances (s+1) between the M first sample features and the first sample features included in the reference feature set s are all less than a convergence distance threshold, it is determined that the reference feature set s satisfies the set convergence condition. If a first feature distance (s+1) greater than or equal to the convergence distance threshold exists in the first feature distances (s+1) between the M first sample features and the first sample features included in the reference feature set s, it is determined that the reference feature set s does not satisfy the set convergence condition.

Operation S705: s++.

In this embodiment of this application, incremental processing is performed on s, and operation S703 is performed again.

Operation S706: Determine the reference feature set s as a target reference feature set corresponding to the image sample, and determine a first sample feature included in the target reference feature set as a target first sample feature.

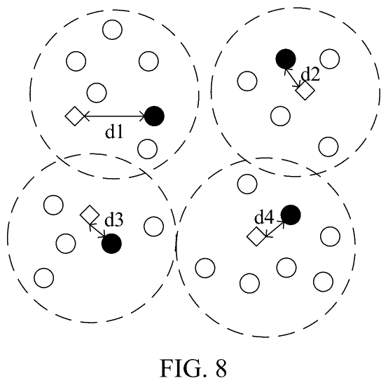

According to the foregoing process, memory occupied by feature maintenance is reduced, thereby reducing resources consumed by feature maintenance and improving the efficiency of data detection. Specifically, FIG. 8 is a schematic diagram showing a feature reduction scene according to an embodiment of this application. As shown in FIG. 8, the M first sample features may be traversed to obtain distances between the M first sample features and the first sample features in the reference feature set, and first feature distances corresponding to the M first sample features are determined. After the traversing is completed, a series of feature pairs may be obtained. Each feature pair includes one of the M first sample features and one first sample feature in the reference feature set. A feature distance of each feature pair, for example, a feature distance d1, a feature distance d2, a feature distance d3, and a feature distance d4 shown in FIG. 8, is a minimum distance between a corresponding first sample feature in the M first sample features and the reference feature set. The reference feature set is updated based on a maximum value of the feature distances corresponding to the feature pairs. For example, assuming that the maximum value is d1, a first sample feature corresponding to d1 in the M first sample features is added to the reference feature set. Formula IV may be referred to for the process:

$${f}_{s}^{*} ← arg {max}_{{f}_{s} ∈ {Q}_{0} - {Q}^{′}} {min}_{{f}_{{q}^{′}} ∈ {Q}^{′}} {‖ {f}_{s} - {f}_{{q}^{′}} ‖}_{2} , \qquad V$$

$${Q}^{′} ← {Q}^{′} ⋃ \{ {f}_{s}^{*} \}$$

As shown in the formula V, Q₀ is configured for representing the M first sample features, Q′ is configured for representing the reference feature set, and ∥ƒₛ−ƒ_{q′}∥₂ is configured for representing a feature distance between a first sample feature fₛ in the M first sample features and a first sample feature f_{q′} in the reference feature set. That is, first feature distances, i.e.,

$${min}_{{f}_{{q}^{′}} ∈ {Q}^{′}} {‖ {f}_{s} - {f}_{{q}^{′}} ‖}_{2} ,$$

corresponding to the M first sample features are first determined, and then, in (Q₀−Q′), a first sample feature, i.e.,

$${f}_{s}^{*} ,$$

with a maximum first feature distance is selected.

$${f}_{s}^{*}$$

is configured for representing a first sample feature that needs to be added to the reference feature set. Further,

$${f}_{s}^{*}$$

is added to the reference feature set to update the reference feature set, denoted as

$${Q}^{′} ← {Q}^{′} ⋃ \{ {f}_{s}^{*} \} ,$$

until the reference feature set (i.e., Q′) satisfies the set convergence condition, and the reference feature set that satisfies the set convergence condition is determined as the target reference feature set.

In this embodiment of this application, the image sample is obtained, and the first sample features corresponding to the image sample are extracted. The target first sample feature with the maximum first feature distance is determined from the plurality of first sample features. The first feature distance is the minimum value of the feature distances between a first sample feature and other first sample features of the first sample features except the first sample feature. Based on the first feature distance between the first sample feature and the target first sample feature, (N+1) sample feature categories corresponding to the first sample features are determined, and the initial feature classification model is trained based on the (N+1) sample feature categories and the plurality of first sample features to obtain the trained feature classification model. N is a positive integer, and the target first sample feature and the trained feature classification model are jointly configured for performing image abnormality detection on the to-be-parsed image. In the foregoing process, only normal samples (i.e., image samples) are used, that is, a defective sample does not need to be used, and modeling is completed using only normal samples so that samples for model training are obtained easily, thereby improving the efficiency of data detection. In addition, since a sufficient number of normal samples for training a model with relatively good robustness may be obtained, the accuracy of data detection is improved. Meanwhile, in the training process, feature reduction is performed on the first sample feature to obtain a more compact and fine-grained sample feature (i.e., the target first sample feature) so that semantic segmentation of a feature distance may be performed based on the sample feature before the feature reduction and the sample feature after the feature reduction to obtain, through training, the trained feature classification model configured for performing image abnormality detection on the to-be-parsed image. Thus, the trained feature classification model may be directly used subsequently to perform image abnormality detection, thereby improving the accuracy and efficiency of data detection.

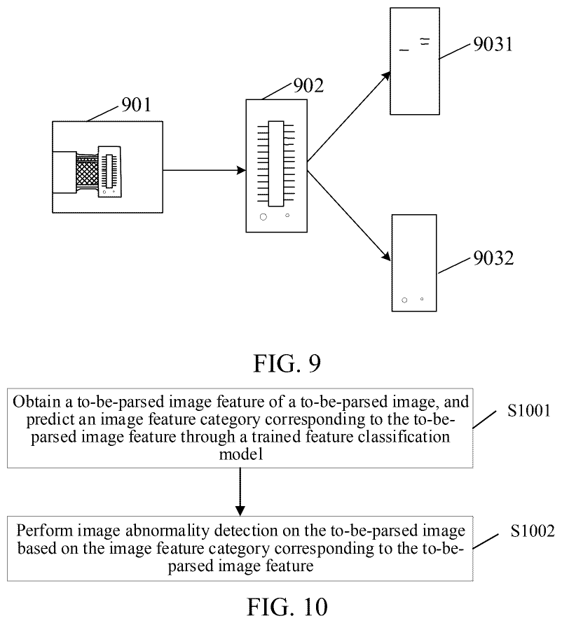

Further, FIG. 9 is a schematic diagram showing an image detection scene according to an embodiment of this application. As shown in FIG. 9, a computer device may acquire an initial acquisition image 901 for a to-be-detected object and perform image registration on the initial acquisition image 901 to obtain a to-be-parsed image 902. Image abnormality detection is performed on the to-be-parsed image 902, for example, pin bending abnormality shown in a region 9031, or solder overflow abnormality shown in a region 9032.

Further, FIG. 10 is a flowchart of another data detection method according to an embodiment of this application. As shown in FIG. 10, the data detection process includes the following operations.

Operation S1001: Obtain a to-be-parsed image feature of a to-be-parsed image, and predict an image feature category corresponding to the to-be-parsed image feature through a trained feature classification model. The to-be-parsed image feature is also referred to as a “target image feature.”

In this embodiment of this application, the trained feature classification model is obtained by training (N+1) sample feature categories divided by a plurality of first sample features, and the plurality of first sample features. N is a positive integer, and the (N+1) sample feature categories are obtained by dividing the plurality of first sample features based on first feature distances between the plurality of first sample features and a target first sample feature. The plurality of first sample features are features extracted from the image sample. The target first sample feature is a first sample feature with a maximum first feature distance among the plurality of first sample features. A target first sample feature refers to a first sample feature with a maximum corresponding first feature distance among the plurality of first sample features, and the first feature distance is a minimum value of feature distances between a first sample feature and other first sample features of the plurality of first sample features except the first sample feature. The (N+1) sample feature categories include N first feature categories and a second feature category. The N first feature categories are configured for indicating that detected data is normal data, and the second feature category is configured for indicating that secondary detection is performed on the detected data.

Operation S1002: Perform image abnormality detection on the to-be-parsed image based on the image feature category corresponding to the to-be-parsed image feature.

In this embodiment of this application, the to-be-parsed image feature includes block features of a plurality of image blocks forming the to-be-parsed image, and the image feature category includes sub-categories of the block features of the plurality of image blocks. If the sub-categories corresponding to the block features of the plurality of image blocks all belong to the N first feature categories, it is determined that the to-be-parsed image is the normal data. If a block feature whose sub-category is the second feature category exists in the block features of the plurality of image blocks, a second feature distance between the to-be-parsed image feature and the target first sample feature is obtained, and image abnormality detection is performed on the to-be-parsed image based on the second feature distance between the to-be-parsed image feature and the target first sample feature. Specifically, the target first sample feature is obtained from a feature memory, and a second feature distance between the to-be-parsed image feature and the target first sample feature is obtained.

Specifically, the to-be-parsed image feature includes the block features of the plurality of image blocks forming the to-be-parsed image. Obtaining, if a block feature whose sub-category is the second feature category exists in the block features of the plurality of image blocks, the second feature distance between the to-be-parsed image feature and the target first sample feature, and performing image abnormality detection on the to-be-parsed image based on the second feature distance between the to-be-parsed image feature and the target first sample feature may be specifically: obtaining, if the block feature whose sub-category is the second feature category exists in the block features of the plurality of image blocks, a to-be-detected block feature (also referred to as a “target block feature”) whose sub-category is the second feature category, and obtaining a second feature distance between the to-be-detected block feature and the target first sample feature. Further, if the second feature distance is less than or equal to a normal distance threshold, the to-be-detected block feature is normal but uncommon. During model training, the to-be-parsed image is not processed, and it may be determined that the to-be-parsed image is normal data. If the second feature distance is greater than the normal distance threshold, the second feature distance is converted into an abnormality degree of the to-be-parsed image. Formula VI may be referred to for the process:

$${f}_{a}^{*} , {f}_{b}^{*} = {arg max}_{{f}_{a} ∈ {C}_{0}} {arg min}_{{f}_{b} ∈ Q} {‖ {f}_{a} - {f}_{b} ‖}_{2} , \qquad VI$$

$$S = {‖ {f}_{a}^{*} - {f}_{b}^{*} ‖}_{2}$$

As shown in the formula VI, C₀ is configured for representing the to-be-detected block feature, Q is configured for representing the feature memory, fₐ is configured for representing a to-be-detected block feature, and f_{b} is configured for representing the target first sample feature belonging to the feature memory. The feature memory is searched for a target first sample feature with a minimum distance to the to-be-detected block feature. In this case, a plurality of to-be-detected feature pairs {fₐ, f_{b}} may be obtained. The to-be-detected feature pair refers to a feature pair formed by the target first sample feature with the minimum distance to the to-be-detected block feature. That is, the second feature distance between the to-be-detected block feature and the target first sample feature may be obtained. The second feature distance refers to a minimum distance between the corresponding to-be-detected block feature and the target first sample feature. Still further, there is one or more to-be-detected block features. If there are a plurality of to-be-detected block features, a target feature pair corresponding to a maximum second feature distance may be obtained from second feature distances corresponding to the plurality of to-be-detected block features, which may be recorded as

$$\{ {f}_{a}^{*} , {f}_{b}^{*} \} .$$

A feature distance, i.e., S, of a target feature pair is obtained. S is compared with the normal distance threshold. If S is less than or equal to the normal distance threshold, it may be determined that the to-be-parsed image is normal data. If S is greater than the normal distance threshold, the feature distance of the target feature pair may be determined as the abnormality degree of the to-be-parsed image.

For example, this application may be applied to performing object detection on a to-be-detected object, that is, may be applied to scenes such as industrial quality inspection. In this scene, the computer device may perform image acquisition on the to-be-detected object to obtain a to-be-parsed image, and perform image abnormality detection on the to-be-parsed image through operation S1001 to operation S1002. Further, when it is determined that the to-be-parsed image is normal data, the to-be-detected object conforms to a manufacturing standard, that is, quality inspection on the to-be-detected object succeeds, and the to-be-detected object may be published. When the abnormality degree of the to-be-parsed image is determined, the to-be-detected object may be processed based on the abnormality degree of the to-be-parsed image. For example, if the abnormality degree is greater than or equal to a destruction abnormality threshold, the to-be-detected object may be destructed. If the abnormality degree is less than the destruction abnormality threshold, an object abnormality prompt message may be fed back to a manager so that the manager may repair or destruct the to-be-detected object based on the object abnormality prompt message. Alternatively, this application may be configured for performing image classification to divide the image data into normal data and abnormal images.

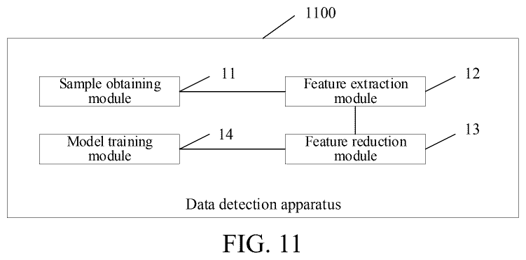

Further, FIG. 11 is a schematic diagram of a data detection apparatus according to an embodiment of this application. The data detection apparatus may be a computer program (including program code, etc.) run on a computer device. For example, the data detection apparatus may be application software. The apparatus may be configured to perform corresponding operations in the methods provided in the embodiments of this application. As shown in FIG. 11, the data detection apparatus 1100 may be applied to the computer device in the embodiment corresponding to FIG. 3. Specifically, the apparatus may include: a sample obtaining module 11, a feature extraction module 12, a feature reduction module 13, and a model training module 14.

The sample obtaining module 11 is configured to obtain an image sample.

The feature extraction module 12 is configured to extract a plurality of first sample features from the image sample.

The feature reduction module 13 is configured to determine a target first sample feature with a maximum first feature distance from the plurality of first sample features, the first feature distance being a minimum value of feature distances between a first sample feature and other first sample features of the plurality of first sample features except the first sample feature.

The model training module 14 is configured to determine, based on the first feature distance, (N+1) sample feature categories corresponding to the first sample features, and train an initial feature classification model based on the (N+1) sample feature categories and the plurality of first sample features to obtain a trained feature classification model, N being a positive integer, and the target first sample feature and the trained feature classification model being jointly configured for performing image abnormality detection on a to-be-parsed image; the (N+1) sample feature categories including N first feature categories and a second feature category; and the N first feature categories being configured for indicating that detected data is normal data, and the second feature category being configured for indicating that secondary detection is performed on the detected data.

The sample obtaining module 11 is specifically configured to:
acquire a to-be-detected object image for a to-be-detected object, and obtaining a template image corresponding to the to-be-detected object, the template image referring to a standard image generated during a design of the to-be-detected object;
perform image registration on the to-be-detected object image using the template image to obtain a registered image, the image registration referring to a process of matching and superimposing two or more images obtained at different times, by different sensors, or under different conditions;
clip a region corresponding to the to-be-detected object from the registered image; and
determine the region corresponding to the to-be-detected object as the image sample.

When performing image registration on the to-be-detected object image using the template image to obtain a registered image, the sample obtaining module 11 is configured to:
detect a first object contour of the to-be-detected object in the to-be-detected object image, and detect a second object contour of the to-be-detected object in the template image; and
obtain contour offset information of the first object contour relative to the second object contour, and perform image rotation and offset processing on the to-be-detected object image based on the contour offset information to obtain the registered image; and
when clipping a region corresponding to the to-be-detected object from the registered image, the sample obtaining module 11 is configured to:
determine a region corresponding to the first object contour in the registered image as a region corresponding to the to-be-detected object in the registered image, and clip the region corresponding to the to-be-detected object.

When performing image registration on the to-be-detected object image using the template image to obtain a registered image, the sample obtaining module 11 may be configured to:
convolve the to-be-detected object image using a Gaussian kernel to obtain a feature matrix of pixels included in the to-be-detected object image;
obtain a matrix parameter weight for the feature matrix, and weight the feature matrix using the matrix parameter weight to obtain pixel feature values of the pixels included in the to-be-detected object image;
perform non-maximum suppression on the to-be-detected object image using the pixel feature values of the pixels included in the to-be-detected object image to determine an initial feature point of the to-be-detected object image, the non-maximum suppression referring to processing of suppressing a non-maximum element and being configured for performing a local maximum search;
perform extremum detection on the initial feature point to obtain a first feature point of the to-be-detected object image, detect wavelet features of the first feature point, and determine a direction of a wavelet feature having a maximum modulus value among the wavelet features of the first feature point as a main feature direction of the first feature point;
construct a first feature vector of the first feature point according to the main feature direction of the first feature point;
detect a second feature point in the template image, and construct a second feature vector of the second feature point; and
perform image registration on the to-be-detected object image and the template image through similarity between the first feature vector and the second feature vector to obtain the registered image; and
when clipping a region corresponding to the to-be-detected object from the registered image, the sample obtaining module 11 is configured to:
clip the region corresponding to the to-be-detected object from the registered image based on an object template corresponding to the template image, the object template being configured for representing position information corresponding to the to-be-detected object in the template image.

The feature extraction module 12 is specifically configured to:
extract an initial image feature from the image sample;
convolve the initial image feature to obtain a residual feature corresponding to the image sample, and perform feature enhancement on the residual feature using the initial image feature to obtain an initial sample feature of the image sample, the initial sample feature including sample block features corresponding to M sample image blocks forming the image sample, and M being a positive integer; and
perform feature fusion on a sample block feature corresponding to a k^{th} sample image block and sample block features of adjacent sample image blocks of the k^{th} sample image block to obtain a first sample feature of the k^{th} sample image block, until first sample features corresponding to the M sample image blocks are obtained, k being a positive integer less than or equal to M.

When convolving the initial image feature to obtain a residual feature corresponding to the image sample, and performing feature enhancement on the residual feature using the initial image feature to obtain an initial sample feature of the image sample, the feature extraction module 12 is configured to:
perform, in an i^{th} network unit, channel downsampling on an (i−1)^{th} enhanced sample feature to obtain an i^{th} downsampling feature, where when i is a first initial value, the (i−1)^{th} enhanced sample feature is the initial image feature; and when i is not the first initial value, the (i−1)^{th} enhanced sample feature is an output feature of an (i−1)^{th} network unit;
perform, in an i^{th} network unit, channel downsampling on an (i−1)^{th} enhanced sample feature to obtain an i^{th} downsampling feature, where when i is a first initial value, the (i−1)^{th} enhanced sample feature is the initial image feature; and when i is not the first initial value, the (i−1)^{th} enhanced sample feature is an output feature of an (i−1)^{th} network unit;
convolve the i^{th} downsampling feature to obtain an i^{th} convolution feature of the image sample;
perform channel upsampling on the i^{th} convolution feature to obtain an i^{th} residual feature of the image sample;
perform feature enhancement on the i^{th} residual feature using the (i−1)^{th} enhanced sample feature to obtain an i^{th} enhanced sample feature of the image sample; and
determine, if the i^{th} network unit is a last network unit, the i^{th} enhanced sample feature as the initial sample feature of the image sample.

When performing feature fusion on a sample block feature corresponding to a k^{th} sample image block and sample block features of adjacent sample image blocks of the k^{th} sample image block to obtain a first sample feature of the k^{th} sample image block, until first sample features corresponding to the M sample image blocks are obtained, the feature extraction module 12 is configured to:
obtain the sample block features of the adjacent sample image blocks of the k^{th} sample image block, and perform pooling on the sample block features of the adjacent sample image blocks to obtain an adjacency-enhanced feature of the k^{th} sample image block, k being a positive integer;
perform feature fusion on the adjacency-enhanced feature of the k^{th} sample image block and the sample block feature corresponding to the k^{th} sample image block to obtain the first sample feature of the k^{th} sample image block; and
obtain, when k is M, the first sample features corresponding to the M sample image blocks.

The first sample features refer to the first sample features corresponding to the M sample image blocks forming the image sample.

The feature reduction module 13 may be configured to:
construct an initial reference feature set, and add a first sample feature corresponding to any sample image block to the initial reference feature set;
obtain, in an s^{th} set construction stage, first feature distances between M first sample features and first sample features included in a reference feature set in an (s−1)^{th} set construction stage, and add a first sample feature corresponding to a maximum first feature distance obtained in the s^{th} set construction stage to the reference feature set obtained in the (s−1)^{th} set construction stage to obtain a reference feature set in the s^{th} set construction stage, s being a positive integer, and when s is a second initial value, the reference feature set in the (s−1)^{th} set construction stage being the initial reference feature set; and
determine, if the reference feature set in the s^{th} set construction stage reaches a set convergence condition, the reference feature set in the s^{th} set construction stage as a target reference feature set corresponding to the image sample, and determine a first sample feature included in the target reference feature set as the target first sample feature.

The number of first sample features is M, and the number of target first sample features is p. M is a positive integer, and p is a positive integer.

The model training module 14 may be configured to:
determine, in a t^{th} iteration, associated sample features fₜ corresponding to pₜ₋₁ target first sample features based on first feature distances between first sample features included in a to-be-detected feature set in a (t−1)^{th} iteration and target first sample features included in an auxiliary feature set in the (t−1)^{th} iteration, where t is a positive integer, and when t is a third initial value, the to-be-detected feature set in the (t−1)^{th} iteration includes the M first sample features; and pₜ₋₁ is a positive integer and refers to the number of target first sample features included in the auxiliary feature set in the (t−1)^{th} iteration;
determine statistical frequency information corresponding to the pₜ₋₁ target first sample features based on the associated sample features fₜ corresponding to the pₜ₋₁ target first sample features, where an associated sample feature fₜ corresponding to a target first sample feature q^{th} with maximum statistical frequency information corresponds to a t^{th} sample feature category;
train an updated feature classification model in the (t−1)^{th} iteration using the t^{th} sample feature category and the to-be-detected feature set in the (t−1)^{th} iteration to obtain an updated feature classification model in the t^{th} iteration, when t is the third initial value, the updated feature classification model in the (t−1)^{th} iteration being the initial feature classification model;
form, if the statistical frequency information corresponding to the pₜ₋₁ target first sample features does not satisfy a statistical convergence condition, a to-be-detected feature set in the t^{th} iteration by other first sample features in the to-be-detected feature set in the (t−1)^{th} iteration except the associated sample feature fₜ corresponding to the target first sample feature qₜ, and perform feature reduction on the to-be-detected feature set in the t^{th} iteration to obtain an auxiliary feature set in the t^{th} iteration; and
determine, if the statistical frequency information corresponding to the pₜ₋₁ target first sample features satisfies the statistical convergence condition, the updated feature classification model in the t^{th} iteration as the trained feature classification model.

The embodiments of this application provide a data detection apparatus. The apparatus may obtain the image sample and extract the first sample features corresponding to the image sample. Feature reduction is performed on the first sample features to obtain the target first sample feature. The first sample feature includes the target first sample feature. Based on the first feature distance between the first sample feature and the target first sample feature, (N+1) sample feature categories corresponding to the first sample features are determined, and the initial feature classification model is trained based on the (N+1) sample feature categories and the plurality of first sample features to obtain the trained feature classification model. N is a positive integer, and the target first sample feature and the trained feature classification model are configured for performing image abnormality detection on the to-be-parsed image. In the foregoing process, only normal samples (i.e., image samples) are used, that is, a defective sample does not need to be used, and modeling is completed using only normal samples so that samples for model training are obtained easily, thereby improving the efficiency of data detection. In addition, since a sufficient number of normal samples for training a model with relatively good robustness may be obtained, the accuracy of data detection is improved. Meanwhile, in the training process, feature reduction is performed on the first sample feature to obtain a more compact and fine-grained sample feature (i.e., the target first sample feature) so that semantic segmentation of a feature distance may be performed based on the sample feature before the feature reduction and the sample feature after the feature reduction to obtain, through training, the trained feature classification model configured for performing image abnormality detection on the to-be-parsed image. Thus, the trained feature classification model may be directly used subsequently to perform image abnormality detection, thereby improving the accuracy and efficiency of data detection.

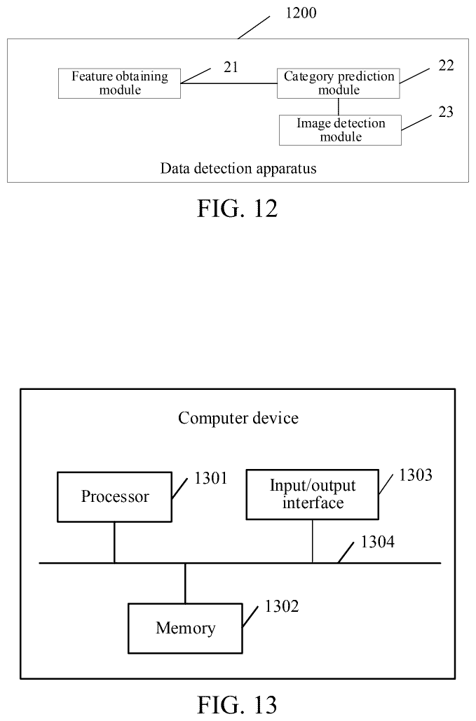

Further, FIG. 12 is a schematic diagram of another data detection apparatus according to an embodiment of this application. The data detection apparatus may be a computer program (including program code, etc.) run on a computer device. For example, the data detection apparatus may be application software. The apparatus may be configured to perform corresponding operations in the methods provided in the embodiments of this application. As shown in FIG. 12, the data detection apparatus 1200 may be applied to the computer device in the embodiment corresponding to FIG. 10. Specifically, the apparatus may include: a feature obtaining module 21, a category prediction module 22, and an image detection module 23.

The feature obtaining module 21 is configured to obtain a to-be-parsed image feature of a to-be-parsed image.

The category prediction module 22 is configured to predict an image feature category corresponding to the to-be-parsed image feature through a trained feature classification model, the trained feature classification model being obtained by training (N+1) sample feature categories divided by first sample features, and the first sample features; N being a positive integer, and the (N+1) sample feature categories being obtained by dividing the plurality of first sample features based on first feature distances corresponding to the plurality of first sample features; the plurality of first sample features being extracted from the image sample; a target first sample feature referring to a first sample feature with a maximum corresponding first feature distance among the plurality of first sample features, and the first feature distance being a minimum value of feature distances between a first sample feature and other first sample features of the plurality of first sample features except the first sample feature; the (N+1) sample feature categories including N first feature categories and a second feature category; and the N first feature categories being configured for indicating that detected data is normal data, and the second feature category being configured for indicating that secondary detection is performed on the detected data.

The image detection module 23 is configured to perform image abnormality detection on the to-be-parsed image based on the image feature category corresponding to the to-be-parsed image feature.

The to-be-parsed image feature includes block features of a plurality of image blocks forming the to-be-parsed image, and the image feature category includes sub-categories corresponding to the block features of the plurality of image blocks. The image detection module 23 may be configured to:
determine, if the sub-categories corresponding to the block features of the plurality of image blocks all belong to the N first feature categories, that the to-be-parsed image is the normal data; and
obtain, if a block feature whose sub-category is the second feature category exists in the block features of the plurality of image blocks, a second feature distance between the to-be-parsed image feature and the target first sample feature, and perform image abnormality detection on the to-be-parsed image based on the second feature distance between the to-be-parsed image feature and the target first sample feature.

The to-be-parsed image feature includes block features of a plurality of image blocks forming the to-be-parsed image, and the image feature category includes sub-categories corresponding to the block features of the plurality of image blocks.

When obtaining, if a block feature whose sub-category is the second feature category exists in the block features of the plurality of image blocks, a second feature distance between the to-be-parsed image feature and the target first sample feature, and performing image abnormality detection on the to-be-parsed image based on the second feature distance between the to-be-parsed image feature and the target first sample feature, the image detection module 23 may be configured to:
obtain, if the block feature whose sub-category is the second feature category exists in the block features of the plurality of image blocks, a to-be-detected block feature whose sub-category is the second feature category, and obtain a second feature distance between the to-be-detected block feature and the target first sample feature;
determine, if the second feature distance is less than or equal to a normal distance threshold, that the to-be-parsed image is the normal data; and
convert, if the second feature distance is greater than the normal distance threshold, the second feature distance into an abnormality degree of the to-be-parsed image.

The embodiments of this application provide a data detection apparatus. The apparatus may obtain the image sample and extract the first sample features corresponding to the image sample. The target first sample feature with the maximum first feature distance is determined from the first sample features. The first sample feature includes the target first sample feature. Based on the first feature distance between the first sample feature and the target first sample feature, (N+1) sample feature categories corresponding to the first sample features are determined, and the initial feature classification model is trained based on the (N+1) sample feature categories and the plurality of first sample features to obtain the trained feature classification model. N is a positive integer, and the target first sample feature and the trained feature classification model are configured for performing image abnormality detection on the to-be-parsed image. In the foregoing process, only normal samples (i.e., image samples) are used, that is, a defective sample does not need to be used, and modeling is completed using only normal samples so that samples for model training are obtained easily, thereby improving the efficiency of data detection. In addition, since a sufficient number of normal samples for training a model with relatively good robustness may be obtained, the accuracy of data detection is improved. Meanwhile, in the training process, feature reduction is performed on the first sample feature to obtain a more compact and fine-grained sample feature (i.e., the target first sample feature) so that semantic segmentation of a feature distance may be performed based on the sample feature before the feature reduction and the sample feature after the feature reduction to obtain, through training, the trained feature classification model configured for performing image abnormality detection on the to-be-parsed image. Thus, the trained feature classification model may be directly used subsequently to perform image abnormality detection, thereby improving the accuracy and efficiency of data detection.

FIG. 13 is a schematic structural diagram of a computer device according to an embodiment of this application. As shown in FIG. 13, the computer device in this embodiment of this application may include: one or more processors 1301, a memory 1302, and an input/output interface 1303. The processor 1301, the memory 1302, and the input/output interface 1303 are connected through a bus 1304. The memory 1302 is configured to store a computer program. The computer program includes a program instruction. The input/output interface 1303 is configured to receive data and output the data, for example, configured to perform data interaction between a business device and the computer device. The processor 1301 is configured to execute the program instruction stored in the memory 1302.

The processor 1301, when being configured to perform model training, may perform the following operations:
obtaining an image sample, and extracting a plurality of first sample features from the image sample;
determining a target first sample feature with a maximum first feature distance from the plurality of first sample features, the first feature distance being a minimum value of feature distances between a first sample feature and other first sample features of the plurality of first sample features except the first sample feature; and
determining, based on the first feature distance, (N+1) sample feature categories corresponding to the plurality of first sample features, and training an initial feature classification model based on the (N+1) sample feature categories and the plurality of first sample features to obtain a trained feature classification model, N being a positive integer, and the target first sample feature and the trained feature classification model being jointly configured for performing image abnormality detection on a to-be-parsed image; the (N+1) sample feature categories including N first feature categories and a second feature category; and the N first feature categories being configured for indicating that detected data is normal data, and the second feature category being configured for indicating that secondary detection is performed on the detected data.

The processor 1301, when being configured to perform model prediction, may perform the following operations:
obtaining a to-be-parsed image feature of a to-be-parsed image, and predicting an image feature category corresponding to the to-be-parsed image feature through a trained feature classification model, the trained feature classification model being obtained by training (N+1) sample feature categories divided by a plurality of first sample features, and the plurality of first sample features; N being a positive integer, and the (N+1) sample feature categories being obtained by dividing the plurality of first sample features based on first feature distances corresponding to the plurality of first sample features; the plurality of first sample features being features extracted from an image sample; a target first sample feature referring to a first sample feature with a maximum corresponding first feature distance among the plurality of first sample features, and the first feature distance being a minimum value of feature distances between a first sample feature and other first sample features of the plurality of first sample features except the first sample feature; the (N+1) sample feature categories including N first feature categories and a second feature category; and the N first feature categories being configured for indicating that detected data is normal data, and the second feature category being configured for indicating that secondary detection is performed on the detected data; and
performing image abnormality detection on the to-be-parsed image based on the image feature category corresponding to the to-be-parsed image feature.

In some feasible implementations, the processor 1301 may be a central processing unit (CPU), or the processor may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The memory 1302 may include a read-only memory and a random access memory and provide instructions and data to the processor 1301 and the input/output interface 1303. A part of the memory 1302 may further include a non-volatile random access memory. For example, the memory 1302 may further store information of a device type.

In a specific implementation, the computer device may perform implementations provided by the operations in FIG. 3 using built-in functional modules of the computer device. For details, reference may be made to the implementations provided by the operations in FIG. 3, which are not described herein again.

The embodiments of this application provide a computer device, including: a processor, an input/output interface, and a memory. The processor obtains a computer program in the memory and performs the operations of the method shown in FIG. 3 to perform data detection operations. In this embodiment of this application, the image sample is obtained, and the first sample features corresponding to the image sample are extracted. Feature reduction is performed on the first sample features to obtain the target first sample feature. The first sample feature includes the target first sample feature. Based on the first feature distance between the first sample feature and the target first sample feature, (N+1) sample feature categories corresponding to the first sample features are determined, and the initial feature classification model is trained based on the (N+1) sample feature categories and the plurality of first sample features to obtain the trained feature classification model. N is a positive integer, and the target first sample feature and the trained feature classification model are configured for performing image abnormality detection on the to-be-parsed image. In the foregoing process, only normal samples (i.e., image samples) are used, that is, a defective sample does not need to be used, and modeling is completed using only normal samples so that samples for model training are obtained easily, thereby improving the efficiency of data detection. In addition, since a sufficient number of normal samples for training a model with relatively good robustness may be obtained, the accuracy of data detection is improved. Meanwhile, in the training process, feature reduction is performed on the first sample feature to obtain a more compact and fine-grained sample feature (i.e., the target first sample feature) so that semantic segmentation of a feature distance may be performed based on the sample feature before the feature reduction and the sample feature after the feature reduction to obtain, through training, the trained feature classification model configured for performing image abnormality detection on the to-be-parsed image. Thus, the trained feature classification model may be directly used subsequently to perform image abnormality detection, thereby improving the accuracy and efficiency of data detection.

The embodiments of this application further provide a computer-readable storage medium, having a computer program stored therein. The computer program is adapted to be loaded and executed by a processor to perform the data detection method provided by the operations in FIG. 3. For details, reference may be made to the implementations provided by the operations in FIG. 3, which are not described herein again. In addition, the descriptions of beneficial effects of the same method are not described herein again. For technical details that are not disclosed in the computer-readable storage medium embodiment of this application, reference may be made to the descriptions of the method embodiments of this application. As an example, the computer program may be deployed to be executed on one computer device, on a plurality of computer devices located at one place, or on a plurality of computer devices distributed at a plurality of places and interconnected through a communication network.

The computer-readable storage medium may be an internal storage unit of the data detection apparatus provided in any one of the foregoing embodiments or an internal storage unit of the computer device, for example, a hard disk or memory of the computer device. The computer-readable storage medium may alternatively be an external storage device of the computer device, for example, a plug-in hard disk, a smart media card (SMC), a secure digital (SD) card, and a flash card that are equipped in the computer device. Further, the computer-readable storage medium may further include both the internal storage unit and the external storage device of the computer device. The computer-readable storage medium is configured to store the computer program and other programs and data required by the computer device. The computer-readable storage medium may further be configured to temporarily store data that has been outputted or is to be outputted.

The embodiments of this application further provide a computer program product or a computer program, including a computer instruction. The computer instruction is stored in a computer-readable storage medium. The processor of the computer device reads the computer instruction from the computer-readable storage medium, and the processor executes the computer instruction to cause the computer device to perform the method provided in the various implementations in FIG. 3. Thus, only normal samples (i.e., image samples) are used, that is, a defective sample does not need to be used, and modeling is completed using only normal samples so that samples for model training are obtained easily, thereby improving the efficiency of data detection. In addition, since a sufficient number of normal samples for training a model with relatively good robustness may be obtained, the accuracy of data detection is improved. Meanwhile, in the training process, feature reduction is performed on the first sample feature to obtain a more compact and fine-grained sample feature (i.e., the target first sample feature) so that semantic segmentation of a feature distance may be performed based on the sample feature before the feature reduction and the sample feature after the feature reduction to obtain, through training, the trained feature classification model configured for performing image abnormality detection on the to-be-parsed image. Thus, the trained feature classification model may be directly used subsequently to perform image abnormality detection, thereby improving the accuracy and efficiency of data detection.

In the specification, claims, and accompanying drawings of the embodiments of this application, the terms “first,” “second,” and so on are intended to distinguish different objects but do not indicate a particular order. In addition, the term “include” and any variant thereof are intended to cover a non-exclusive inclusion. For example, processes, methods, apparatuses, products, or devices containing a series of steps or units are not limited to the listed steps or units, but alternatively include steps or units that are not listed, or alternatively include other steps or units that are inherent to these processes, methods, apparatuses, products, or devices.

A person skilled in the art may realize that the units and algorithm steps in the examples described in conjunction with the embodiments disclosed herein may be implemented in electronic hardware, computer software, or a combination of the two. To clearly illustrate the interchangeability of hardware and software, the composite and steps of the examples have been described generally according to functions. Whether these functions are implemented in hardware or software depends on the specific application and design constraints of the technical solutions. For each particular application, a person skilled in the art may use different methods to achieve the described function, but this implementation shall not be considered outside the scope of this application.

The methods and related apparatuses provided in the embodiments of this application are described with reference to the method flowcharts and/or schematic structural diagrams provided in the embodiments of this application. Specifically, each flow and/or block in the method flowcharts and/or schematic structural diagrams and a combination of flows and/or blocks in the flowcharts and/or block diagrams may be implemented by computer program instructions. These computer program instructions may be provided to a general-purpose computer, a dedicated computer, an embedded processing machine, or a processor of another programmable data detection device to generate a machine so that the instructions executed by the computer or the processor of the another programmable data detection device generate an apparatus configured to implement the functions specified in one or more processes of the flowcharts and/or one or more blocks of the schematic structural diagrams. These computer program instructions may alternatively be stored in a computer-readable memory that can guide a computer or another programmable data detection device to operate in a specific manner so that the instructions stored in the computer-readable memory generate an artifact including an instruction apparatus. The instruction apparatus implements the functions specified in one or more processes of the flowcharts and/or one or more blocks of the schematic structural diagrams. These computer program instructions may alternatively be loaded onto a computer or another programmable data detection device so that a series of operations and steps are performed on the computer or the another programmable device, thereby generating computer-implemented processing. Therefore, the instructions executed on the computer or the another programmable device provide operations for implementing the functions specified in one or more processes of the flowcharts and/or one or more blocks of the schematic structural diagrams.

The operations of the methods in the embodiments of this application may be sequentially adjusted, combined, and deleted according to actual needs.

The modules of the apparatuses of the embodiments of this application may be combined, divided, or deleted according to actual needs.

What is disclosed above is merely exemplary embodiments of this application, and certainly is not intended to limit the scope of the claims of this application. Therefore, equivalent variations made in accordance with the claims of this application shall fall with in the scope of this application.

What is claimed is:

1. A data detection method comprising:
obtaining an image sample;
extracting a plurality of sample features from the image sample;
determining a target sample feature with a maximum nearest-neighbor feature distance among the plurality of sample features, the nearest-neighbor feature distance of one sample feature being a minimum value of feature distances between the one sample feature and other ones of the plurality of sample features except the one sample feature;
determining, based on the nearest-neighbor feature distances of the plurality of sample features, (N+1) sample feature categories corresponding to the plurality of sample features, N being a positive integer; and
training an initial feature classification model based on the (N+1) sample feature categories and the plurality of sample features to obtain a trained feature classification model, the (N+1) sample feature categories including N first feature categories configured for indicating detected data being normal data and a second feature category configured for indicating to perform secondary detection on the detected data.

2. The method according to claim 1, wherein obtaining the image sample includes:
acquiring a target object image for a target object;
obtaining a template image corresponding to the target object, the template image being a standard image generated during design of the target object;
performing image registration on the target object image using the template image to obtain a registered image, image registration being a process of matching and superimposing two or more images obtained at different times, by different sensors, or under different conditions; and
clipping, from the registered image, a region corresponding to the target object as the image sample.

3. The method according to claim 1, wherein:
performing image registration on the target object image includes:
detecting a first object contour of the target object in the target object image;
detecting a second object contour of the target object in the template image;
obtaining contour offset information of the first object contour relative to the second object contour; and
performing image rotation and offset processing on the target object image based on the contour offset information to obtain the registered image; and
clipping the region corresponding to the target object from the registered image includes:
determining a region corresponding to the first object contour in the registered image as a region corresponding to the target object in the registered image, and clipping the region corresponding to the target object.

4. The method according to claim 1, wherein:
performing image registration on the target object image includes:
convolving the target object image using a Gaussian kernel to obtain a feature matrix of pixels in the target object image;
obtaining a matrix parameter weight for the feature matrix;
weighting the feature matrix using the matrix parameter weight to obtain pixel feature values of the pixels in the target object image;
performing non-maximum suppression on the target object image using the pixel feature values to obtain an initial feature point of the target object image, non-maximum suppression including suppressing a non-maximum element and being configured for performing a local maximum search;
performing extremum detection on the initial feature point to obtain a first feature point of the target object image;
detecting wavelet features of the first feature point;
determining a direction of a wavelet feature having a maximum modulus value among the wavelet features of the first feature point as a main feature direction of the first feature point;
constructing a first feature vector of the first feature point according to the main feature direction of the first feature point;
detecting a second feature point in the template image, and constructing a second feature vector of the second feature point; and
performing image registration on the to target object image and the template image through similarity between the first feature vector and the second feature vector to obtain the registered image; and
clipping the region corresponding to the target object from the registered image includes:
clipping the region corresponding to the target object from the registered image based on an object template corresponding to the template image, the object template representing position information corresponding to the target object in the template image.

5. The method according to claim 1, wherein extracting the plurality of sample features from the image sample includes:
extracting an initial image feature from the image sample;
convolving the initial image feature to obtain a residual feature of the image sample;
performing feature enhancement on the residual feature using the initial image feature to obtain an initial sample feature of the image sample, the initial sample feature including sample block features corresponding to M sample image blocks forming the image sample, and M being a positive integer; and
for each sample image block of the M sample image blocks, performing feature fusion on a sample block feature corresponding to the sample image block and sample block features of adjacent sample image blocks of the sample image block to obtain a sample feature of the sample image block.

6. The method according to claim 5, wherein:
convolving the initial image feature includes:
performing, in an i^{th} network unit, channel downsampling on an (i−1)^{th} enhanced sample feature to obtain an i^{th} downsampling feature, the (i−1)^{th} enhanced sample feature being:
the initial image feature when i is an initial value, and
an output feature of an (i−1)^{th} network unit when i is not the initial value;
convolving the i^{th} downsampling feature to obtain an i^{th} convolution feature of the image sample; and
performing channel upsampling on the i^{th} convolution feature to obtain an i^{th} residual feature of the image sample; and
performing feature enhancement on the residual feature includes:
performing feature enhancement on the i^{th} residual feature using the (i−1)^{th} enhanced sample feature to obtain an i^{th} enhanced sample feature of the image sample; and
determining, in response to the i^{th} network unit being a last network unit, the i^{th} enhanced sample feature as the initial sample feature of the image sample.

7. The method according to claim 5, wherein for one sample block feature, performing feature fusion on the one sample block feature includes:
performing pooling on the sample block features of the adjacent sample image blocks of the one sample image block to obtain an adjacency-enhanced feature of the one sample image block; and
performing feature fusion on the adjacency-enhanced feature of the one sample image block and the sample block feature corresponding to the one sample image block to obtain the sample feature of the one sample image block.

8. The method according to claim 1, wherein:
the plurality of sample features correspond to M sample image blocks forming the image sample, respectively, M being a positive integer; and
determining the target sample feature includes:
constructing an initial reference feature set, and adding any of the sample features to the initial reference feature set;
in an s^{th} set construction stage, obtaining feature distances between M sample features and sample features in a reference feature set in an (s−1)^{th} set construction stage, and adding a sample feature corresponding to a maximum feature distance obtained in the s^{th} set construction stage to the reference feature set in the (s−1)^{th} set construction stage to obtain a reference feature set in the s^{th} set construction stage, s being a positive integer, and when s is an initial value, the reference feature set in the (s−1)^{th} set construction stage being the initial reference feature set; and
in response to the reference feature set in the s^{th} set construction stage satisfying a set convergence condition, determining the reference feature set in the s^{th} set construction stage as a target reference feature set corresponding to the image sample, and determining a sample feature in the target reference feature set as the target sample feature.

9. The method according to claim 1, wherein:
a number of the sample features is M, and M is a positive integer; and
determining the (N+1) sample feature categories and training the initial feature classification model include:
in a t^{th} iteration, determining associated sample features ft corresponding to pₜ₋₁ target sample features, respectively, based on feature distances between sample features in a target feature set in a (t−1)^{th} iteration and target sample features in an auxiliary feature set in the (t−1)^{th} iteration, t being a positive integer, the target feature set in the (t−1)^{th} iteration including the M sample features when t is an initial value, and pₜ₋₁ being a positive integer and referring to a number of target sample features in the auxiliary feature set in the (t−1)^{th} iteration;
determining statistical frequency information corresponding to the pₜ₋₁ target sample features based on the associated sample features ft corresponding to the pₜ₋₁ target first sample features, respectively, and determining an associated sample feature fₜ corresponding to a target sample feature q^{th} with maximum statistical frequency information as corresponding to a t^{th} sample feature category;
training an updated feature classification model in the (t−1)^{th} iteration using the t^{th} sample feature category and the target feature set in the (t−1)^{th} iteration to obtain an updated feature classification model in the t^{th} iteration, the updated feature classification model in the (t−1)^{th} iteration being the initial feature classification model when t is the initial value;
in response to the statistical frequency information corresponding to the pₜ₋₁ target sample features not satisfying a statistical convergence condition, forming a target feature set in the t^{th} iteration by other sample features in the target feature set in the (t−1)^{th} iteration except the associated sample feature fₜ corresponding to the target sample feature qₜ, and obtaining an auxiliary feature set in the t^{th} iteration from the target feature set in the t^{th} iteration; and
in response to the statistical frequency information corresponding to the pₜ₋₁ target sample features satisfying the statistical convergence condition, determining the updated feature classification model in the t^{th} iteration as the trained feature classification model.

10. A non-transitory computer-readable storage medium storing a computer program that, when executed by a processor, causes a computer device having the processor to perform the method according to claim 1.

11. A data detection method comprising:
obtaining a target image feature of a target image;
predicting an image feature category corresponding to the target image feature through a trained feature classification model; and
performing image abnormality detection on the target image based on the image feature category corresponding to the target image feature;
wherein:
the trained feature classification model is obtained by training a plurality of sample features extracted from an image sample and (N+1) sample feature categories corresponding to the plurality of sample features, N being a positive integer;
the (N+1) sample feature categories are obtained by dividing the plurality of sample features based on feature distances corresponding to the plurality of sample features;
the target sample feature is a sample feature with a maximum corresponding feature distance among the plurality of sample features, a feature distance corresponding to one sample feature being a minimum value of feature distances between the one sample feature and other ones of the plurality of first sample features except the first sample feature; and
the (N+1) sample feature categories include N first feature categories configured for indicating detected data being normal data and a second feature category being configured for indicating to perform secondary detection on the detected data.

12. The method according to claim 11, wherein:
the feature distances are first feature distances;
the target image feature includes block features of a plurality of image blocks forming the target image, and the image feature category includes sub-categories corresponding to the block features of the plurality of image blocks; and
performing image abnormality detection includes:
in response to the sub-categories all belonging to the N first feature categories, determining that the target image is the normal data; and
in response to at least one of the sub-categories being the second feature category, obtaining a second feature distance between the target image feature and the target sample feature, and performing image abnormality detection on the target image based on the second feature distance.

13. The method according to claim 11, wherein obtaining the second feature distance and performing image abnormality detection based on the second feature distance includes:
obtaining a target block feature and a second feature distance between the target block feature and the target sample feature, the sub-category corresponding to the target block feature is the second feature category;
determining that the target image is the normal data in response to the second feature distance corresponding to the target block feature being less than or equal to a normal distance threshold; and
converting the second feature distance corresponding to the target block feature into an abnormality degree of the target image in response to the second feature distance corresponding to the target block feature being greater than the normal distance threshold.

14. A computer device comprising:
a memory storing a computer program; and
a processor configured to invoke the computer program to cause the computer device to perform the method according to 11.

15. A non-transitory computer-readable storage medium storing a computer program that, when executed by a processor, causes a computer device having the processor to perform the method according to claim 11.

16. A computer device comprising:
a memory storing a computer program; and
a processor configured to invoke the computer program to cause the computer device to:
obtain an image sample;
extract a plurality of sample features from the image sample;
determine a target sample feature with a maximum nearest-neighbor feature distance among the plurality of sample features, the nearest-neighbor feature distance of one sample feature being a minimum value of feature distances between the one sample feature and other ones of the plurality of sample features except the one sample feature;
determine, based on the nearest-neighbor feature distances of the plurality of sample features, (N+1) sample feature categories corresponding to the plurality of sample features, N being a positive integer; and
train an initial feature classification model based on the (N+1) sample feature categories and the plurality of sample features to obtain a trained feature classification model, the (N+1) sample feature categories including N first feature categories configured for indicating detected data being normal data and a second feature category configured for indicating to perform secondary detection on the detected data.

17. The computer device according to claim 16, wherein the processor is further configured to invoke the computer program to cause the computer device to, when obtaining the image sample:
acquire a target object image for a target object;
obtain a template image corresponding to the target object, the template image being a standard image generated during design of the target object;
perform image registration on the target object image using the template image to obtain a registered image, image registration being a process of matching and superimposing two or more images obtained at different times, by different sensors, or under different conditions; and
clip, from the registered image, a region corresponding to the target object as the image sample.

18. The computer device according to claim 16, wherein the processor is further configured to invoke the computer program to cause the computer device to:
when performing image registration on the target object image:
detect a first object contour of the target object in the target object image;
detect a second object contour of the target object in the template image;
obtain contour offset information of the first object contour relative to the second object contour; and
perform image rotation and offset processing on the target object image based on the contour offset information to obtain the registered image; and
when clipping the region corresponding to the target object from the registered image:
determine a region corresponding to the first object contour in the registered image as a region corresponding to the target object in the registered image, and clip the region corresponding to the target object.

19. The computer device according to claim 16, wherein the processor is further configured to invoke the computer program to cause the computer device to:
when performing image registration on the target object image includes:
convolve the target object image using a Gaussian kernel to obtain a feature matrix of pixels in the target object image;
obtain a matrix parameter weight for the feature matrix;
weight the feature matrix using the matrix parameter weight to obtain pixel feature values of the pixels in the target object image;
perform non-maximum suppression on the target object image using the pixel feature values to obtain an initial feature point of the target object image, non-maximum suppression including suppressing a non-maximum element and being configured for performing a local maximum search;
perform extremum detection on the initial feature point to obtain a first feature point of the target object image;
detect wavelet features of the first feature point;
determine a direction of a wavelet feature having a maximum modulus value among the wavelet features of the first feature point as a main feature direction of the first feature point;
construct a first feature vector of the first feature point according to the main feature direction of the first feature point;
detect a second feature point in the template image, and constructing a second feature vector of the second feature point; and
perform image registration on the to target object image and the template image through similarity between the first feature vector and the second feature vector to obtain the registered image; and
when clipping the region corresponding to the target object from the registered image:
clip the region corresponding to the target object from the registered image based on an object template corresponding to the template image, the object template representing position information corresponding to the target object in the template image.

20. The computer device according to claim 16, wherein the processor is further configured to invoke the computer program to cause the computer device to, when extracting the plurality of sample features from the image sample:
extract an initial image feature from the image sample;
convolve the initial image feature to obtain a residual feature of the image sample;
perform feature enhancement on the residual feature using the initial image feature to obtain an initial sample feature of the image sample, the initial sample feature including sample block features corresponding to M sample image blocks forming the image sample, and M being a positive integer; and
for each sample image block of the M sample image blocks, perform feature fusion on a sample block feature corresponding to the sample image block and sample block features of adjacent sample image blocks of the sample image block to obtain a sample feature of the sample image block.
